(19) United States
(12) Patent Application Publication
(10) Pub. No.: US 2008/0144655 A1
(43) Pub. Date: Jun. 19, 2008

(54) Systems, methods, and computer program products for passively transforming internet protocol (IP) network traffic

(76) Inventors: James Frederick Beam, Raleigh, NC (US); Byron Lee Hargett, Apex, NC (US); Douglas Wayne Hester, Cary, NC (US); Ricky G. Millham, Cary, NC (US); Jennifer Justina Short, Apex, NC (US); Garth Douglas Somerville, Cary, NC (US); Jason Moore Walker, Chapel Hill, NC (US); Virgil Montgomery Wall, Apex, NC (US); Robert Edward Ward, Morrisville, NC (US)

Correspondence Address: JENKINS, WILSON, TAYLOR & HUNT, P. A., 3100 TOWER BLVD., Suite 1200, DURHAM, NC, 27707, US

(21) Appl. No.: 11/655,726

(22) Filed: Jan. 19, 2007

Related U.S. Application Data
(60) Provisional application No. 60/874,805, filed on Dec. 14, 2006.

(51) Int. Cl. H04J 3/16

(52) U.S. Cl. 370/466; 370/401

(57) ABSTRACT

Methods, systems, and computer program products for passively transforming IP network traffic are disclosed. According to one aspect, a method includes identifying one of an application protocol event and a business-level event in IP network traffic. Data associated with the identified event can be transformed into a usable format. Further, the transformed data can be fed in real-time to a backend system.

### RELATED APPLICATIONS

The presently disclosed subject matter claims the benefit of the U.S. Provisional Patent Application Ser. No. 60/874,805, entitled “Capture-Transform-Feed for Real-Time Data Integration” and filed Dec. 14, 2006, the disclosure of which is incorporated herein by reference in its entirety.

### TECHNICAL FIELD

The subject matter described herein relates to transforming network traffic. More particularly, the subject matter described herein relates to systems, methods, and computer program products for passively transforming Internet protocol (IP) network traffic.

### BACKGROUND

Businesses that conduct online interactions with their customers via Internet-facing software applications face two Information Technology (IT)-related challenges. The first is the delivery of the applications and the second is the associated monitoring of the applications. Application monitoring is required to meet diverse requirements including online fraud detection, web analytics and customer experience management, performance monitoring, regulatory compliance, and operational business intelligence (also referred to as “Business Activity Monitoring”).

The process of capturing the operational data and delivering the operational data in a usable form into backend analytical systems is referred to as data integration. Typical data integration techniques rely on server log files generated by the applications themselves to supply the operational data. These log files must be aggregated across many servers, batch-processed into a form required by a backend system, and finally the transformed data is batch loaded into a database (or data warehouse). Alternative techniques used with online fraud detection include requiring changes to the application software to directly communicate fraud parameters to the backend system, or installing agent software on each application server to intercept and gather fraud parameters. Implementing a data integration solution is often the most expensive and time consuming aspect of any monitoring project. The traditional approaches do not adequately support real-time acquisition and dissemination of business intelligence because they often require aggregation of log files, batch processing to transform the data, and data warehouses may sit between the point of acquisition and the analytical system.

Complex event processing is an emerging technology for processing and correlating high volumes of events in real-time. There is a need to supply these solutions with real-time streams of events acquired from operational data. The lack of existing deployable data integration solutions that can generate event streams in real-time hinders the wide spread use of complex event processing and event stream.

There is a need for a solution that captures desired business intelligence in real-time and delivers it into backend analytical systems without incurring excessive maintenance or runtime costs to the application delivery infrastructure (referred to as a “production environment”). There is also a need for supporting real-time events across the enterprise with a centralized network-based infrastructure solution rather than multiple independent components integrated into each monitoring application.

Accordingly, in light of the above described difficulties and needs, there exists a need for improved systems, methods, and computer program products for passively transforming network traffic into a usable format for feed to backend systems.

### SUMMARY

The subject matter described herein includes systems, methods, and computer program products for passively transforming IP network traffic. According to one aspect, the subject matter described herein includes a method for passively transforming IP network traffic. The method includes identifying one of an application protocol event and a business-level event in IP network traffic. Data associated with the identified event can be transformed into a usable format. Further, the transformed data can be fed in real-time to a backend system.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium.

More specific examples (a non-exhaustive list) of the computer readable medium can include the following: a wired network connection and associated transmission medium, such as an Ethernet transmission system, a wireless network connection and associated transmission medium, such as an IEEE 802.11(a), (b), or (g) or a Bluetooth™ transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

It is an object of the presently disclosed subject matter to provide novel systems, methods, and computer program products for passively transforming IP network traffic.

An object of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

Preferred embodiments of the subject matter described herein will now be explained with reference to the accompanying drawings of which:

FIG. 1 is a block diagram of an exemplary network environment including a system for passively transforming IP network data associated with application protocol and business-level events in real-time according to an embodiment of the subject matter described herein;

FIG. 2 is a block diagram of exemplary details of the system shown in FIG. 1 according to an embodiment of the subject matter described herein;

FIG. 3 is a flow chart of an exemplary process for passively transforming IP network data associated with application protocol and business-level event in real-time performed by the system of FIGS. 1 and 2 according to an embodiment of the subject matter described herein;

FIG. 4 is a block diagram illustrating exemplary details of a capture engine according to an embodiment of the subject matter described herein;

FIG. 5 is a flow chart of exemplary processing steps performed by the capture engine of FIG. 4 according to an embodiment of the subject matter described herein;

FIG. 6 is a flow chart of exemplary processing steps performed by an HTTP reassembly engine of FIG. 4 according to an embodiment of the subject matter described herein;

FIG. 7 is a block diagram of exemplary details of a transformation engine according to an embodiment of the subject matter described herein;

FIGS. 8A, 8B, and 8C are flow charts of exemplary processes of traffic sessionization according to an embodiment of the subject matter described herein;

FIG. 9A is a flow chart of an exemplary process for generating simple business-level event data based on individual HTTP transactions according to an embodiment of the subject matter described herein;

FIG. 9B is a flow chart of an exemplary process for generating complex business-level events from a sequence of simple business-level events within a user session according to an embodiment of the subject matter described herein;

FIG. 10 is a block diagram of exemplary details of a feed engine shown in FIG. 2 according to an embodiment of the subject matter described herein;

FIG. 11 is a flow chart of an exemplary process for using a JDBC database pump according to an embodiment of the subject matter described herein;

FIG. 12 is an exemplary flow chart of the operation of a JDBC pump according to an embodiment of the subject matter described herein;

FIG. 13 is a screen display of capture traffic configuration presented by a display of a computer workstation according to an embodiment of the subject matter described herein;

FIG. 14 is a screen display for filtering traffic presented by a display of a computer workstation according to an embodiment of the subject matter described herein;

FIG. 15 is a screen display for masking of sensitive data contained in HTTP requests according to an embodiment of the subject matter described herein;

FIG. 16 is a screen display for use in configuring a calculation of a user's IP address according to an embodiment of the subject matter described herein;

FIG. 17 is a screen display for use in configuring the system of FIG. 1 with information about how the application(s) being monitored manages HTTP sessions according to an embodiment of the subject matter described herein;

FIG. 18 is a screen display for use in configuring business-level events that the system of FIG. 1 can generate from underlying application traffic according to an embodiment of the subject matter described herein;

FIG. 19 is a screen display for use in configuring the output feeds generated by the system of FIG. 1 according to an embodiment of the subject matter described herein;

FIG. 20 is a screen display of exemplary information for a pump that writes captured and transformed events into a data table using a JDBC interface according to an embodiment of the subject matter described herein; and

FIG. 21 is a screen display showing JDBC configuration for a pump according to an embodiment of the subject matter described herein.

### DETAILED DESCRIPTION

The subject matter described herein provides systems, methods, and computer program products for passively transforming IP network data associated with application protocol and business-level events in real-time. According to one aspect, a system according to the subject matter described herein can passively capture raw IP network data, identify at least one of an application protocol event and a business-level event in the IP network data, transform the IP network data associated with the identified event into a usable format, and feed the transformed data to a backend system in real-time. Further, the systems, methods, and computer products described herein can retrieve application protocol events in accordance with different protocols. Backend systems can receive the transformed data and perform monitoring actions such as, for example, fraud detection, anti-money laundering, web analytics, real-time customer experience management, and performance monitoring. Further, systems, methods, and computer program products in accordance with the subject matter described herein can provide real-time operations using out-of-band monitoring, provide an enterprise-wide solution that simultaneously supports multiple backend systems, and require minimal or no changes to the production environment or application delivery processes.

Passive network capture may be performed by obtaining copies of network traffic from switched port analyzer (SPAN) ports or mirror ports on network switches. Copies of network traffic can also be obtained from a physical line test port analyzer (TAP). In either case, the acquisition of copies of network packets can be implemented for introducing no latency and/or effect into the production network being monitored. The presence of a system passively capturing traffic is generally undetectable by end users or application servers using the network.

In one embodiment, systems in accordance with the subject matter described herein can filter identified application protocol events and higher level business events for inclusion or exclusion. Further, the identified events can be transformed from their form as protocol-formatted network data into a format usable by a backend analytical system. Transformation can include extracting predetermined attributes, discarding other predetermined attributes, and augmenting the events with additional information such as a user identity, session information, and/or IP geolocation information. Systems in accordance with the subject matter described herein can then simultaneously route transformed events to one or more configured output pumps. The output pumps can be configured to further filter selected events and deliver the resulting event stream to one or more backend systems for real-time processing. The system can capture business relevant operational data while “inflight”.

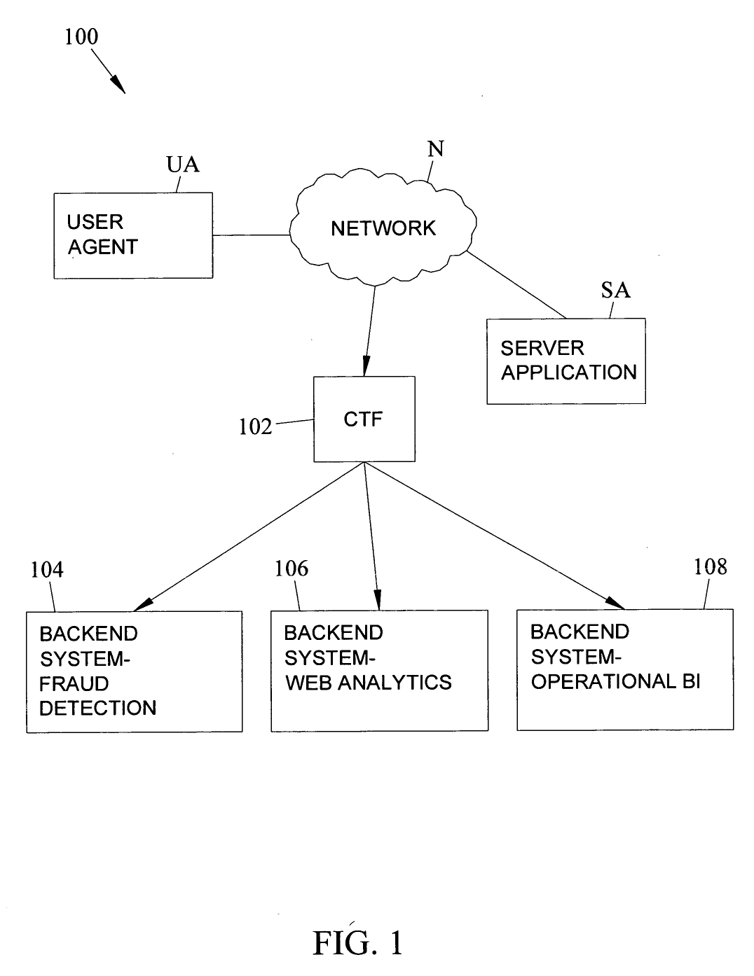

FIG. 1 is a block diagram of an exemplary network environment, generally designated 100, including a capture-transform-feed system 102 for passively transforming IP network traffic data associated with application protocol and business-level events in real-time according to an embodiment of the subject matter described herein. Referring to FIG. 1, a network N can provide communications between a user agent UA and a server application SA via any suitable communications protocol. User agent UA and server application SA can communicate by exchanging message packets via network N. In one example, network N is the Internet and message packets can be exchanged via network N using IP. Further, in this example, a user can interact with server application SA by use of user agent UA, which may be a web browser operating on any suitable electronic device. The web-based application can be Internet facing, or may be an internal application hosted within a private local area network (LAN) or a wide area network (WAN). User agent UA may be a web browser or any web-enabled device configured to allow a user to interact with network N. System 102 is configured to monitor client-server exchanges between user agent UA and server application SA.

As described in more detail herein, system 102 can include a capture engine, a transformation engine, and a feed engine. The capture engine can be configured to identify at least one of an application protocol event and a business-level event in IP network data. The transformation engine can be configured to transform the IP network data associated with the identified event into a usable format. The feed engine can be configured to feed the transformed data to one or more of backend systems 104,106, and 108 in real-time. Backend systems 104, 106, and 108 are configured to perform fraud detection monitoring, web analytics, and operation business intelligence monitoring, respectively.

System 102 can use passive network-based capture as a source of raw data to monitor business activity. In one example, passive network capture includes one or more physical network interfaces connected to a mirror port on a switch or a TAP of network N. The switch or TAP can generate copies of IP packets and deliver them to CTF system 102. Because system 102 can process a copy of the production application traffic, system 102 does not disrupt, delay, or alter the client-server exchanges between user agents and application servers.

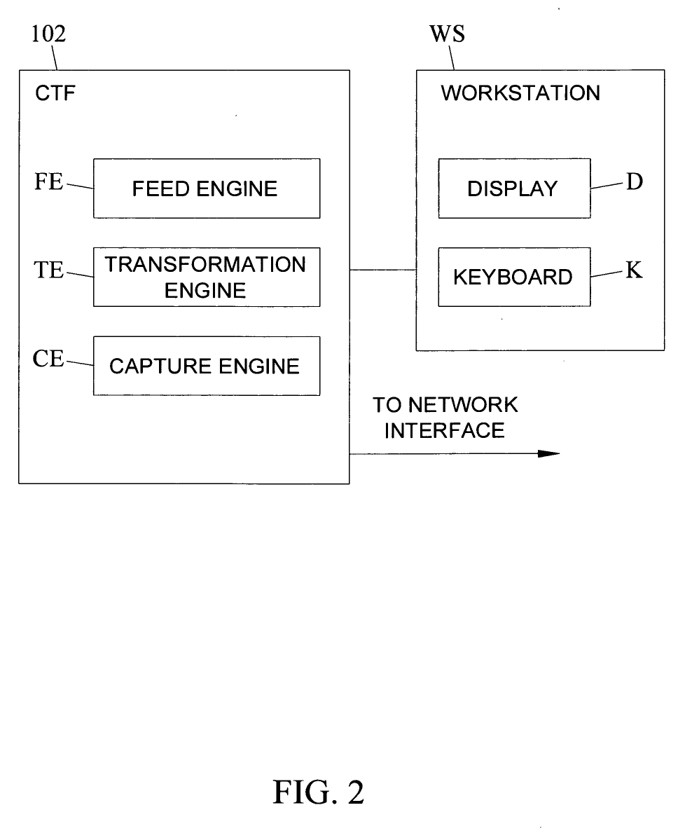

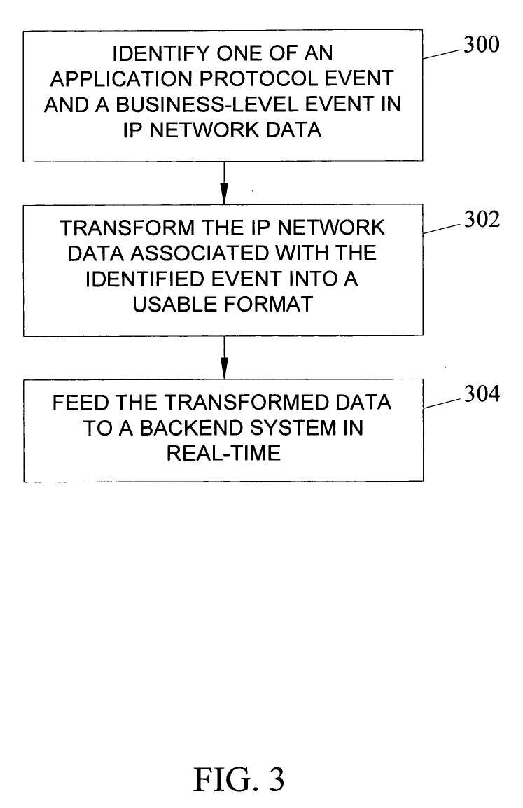

FIG. 2 is a block diagram illustrating exemplary details of system 102 shown in FIG. 1 according to an embodiment of the subject matter described herein. Referring to FIG. 2, system 102 can include a capture engine CE, a transformation engine TE, and a feed engine FE. FIG. 3 is a flow chart illustrating an exemplary process for passively transforming IP network data associated with application protocol and business-level event in real-time performed by system 102 of FIGS. 1 and 2 according to an embodiment of the subject matter described herein. Referring to FIGS. 2 and 3, in block 300, capture engine CE can identify one of an application protocol event and a business-level event in IP network data. In block 302, transformation engine TE can transform the IP network data associated with the identified event into a usable format. In block 304, feed engine FE can feed the transformed data to a backend system in real-time.

Further, system 102 can be in electrical communication with a computer workstation WS. Workstation WS can include user interface devices such as a display D and a keyboard K. A user may interact with workstation WS for operating system 102 and for monitoring retrieved network data and network data analysis information provided by system 102. In one example, workstation WS can run a web browser configured to communicate with system 102 for displaying activity information about the traffic and events passing through system 102 and for configuring the behavior, parameters, and output pumps of system 102.

### Capture Engine

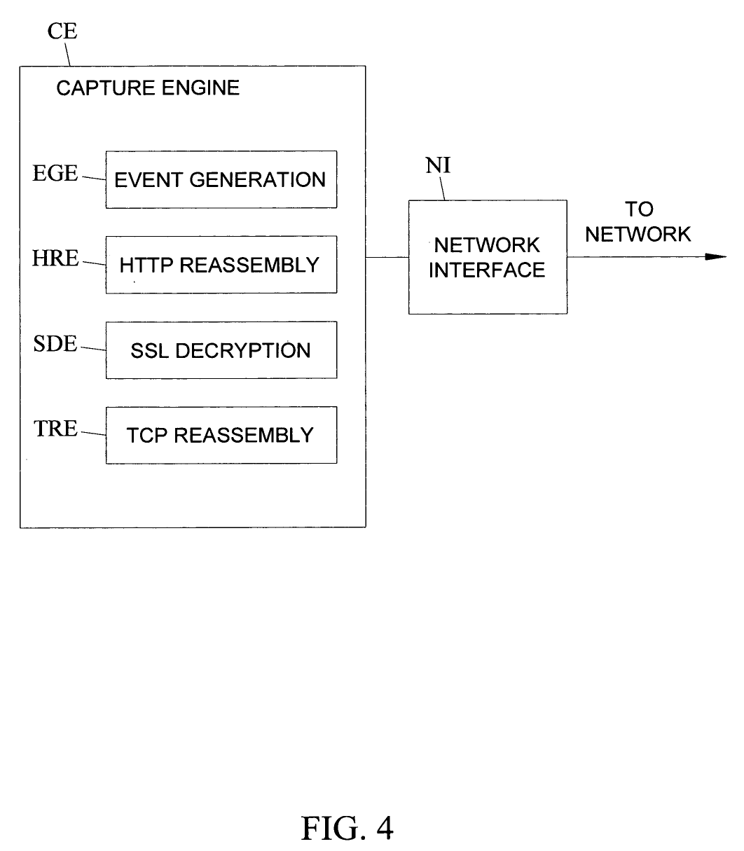

Capture engine CE includes interoperable components that are configured to convert raw IP network traffic into application-level events in real-time. FIG. 4 is a block diagram illustrating exemplary details of capture engine CE according to an embodiment of the subject mailer described herein. Referring to FIG. 4, IP packets are passively captured from a network interface NI and reassembled into TCP streams by a TCP reassembly engine TRE. In one example, a passive network stack can reconstruct TCP streams between user agents and the application servers from the copies of IP packets. Further, reassembly engine TRE may arrange packets from many independent TCP connections between clients and servers into proper order within each connection. Reassembly engine TRE can manage out-of-sequence packets, fragmented packets, and virtual local area network (VLAN) tagged packets.

In one example, application traffic can be encrypted using SSL. Capture engine CE can include an SSL decryption engine SDE configured to decrypt application traffic when provided server private keys. Further, SSL decryption engine SDE may be configured to support multiple versions of SSL such as SSL 2.0, SSL 3.0, and TLS 1.0. The implementation can include decryption in software or hardware-based SSL acceleration. The server private keys can be stored and managed within Federal Information Processing Standard (FIPS) Publication 140-2 compliant hardware security modules. The FIPS 140-2 standard is a U.S. government computer security standard used to accredit cyptographic modules.

Decrypted TCP traffic can be fed to an HTTP reassembly module HRE. Module HRE can be configured to reconstruct the application layer protocol from the underlying TCP client-server conversation. HTTP (Hypertext Transfer Protocol) is an Internet Standard application protocol defined in RFC 2616 for allowing a client web enabled device (also referred to as a “User Agent”) to communicate with a web server, and to exchange information in both directions. Further, capture engine CE can include one or more other reassembly modules configured to process and identify other suitable protocols such as hypertext transfer protocol over secure socket layer (HTTPS). Other exemplary protocols include simple mail transfer protocol (SMTP), post office protocol (POP), session initialization protocol (SIP) including voice and chat, and Telnet protocols (TN3270).

An event generation engine EGE can be configured to generate asynchronous application-level events based on the application protocol, thus transforming the flow of application traffic into discrete events with relevant attributes. HTTP parsing can identify all attributes of requests and responses and captures the full content of application server responses. These attributes and response content can be prepared into discrete events for processing by the transformation layer. Separate events can be generated that correspond to each HTTP request, HTTP responses, and completed HTTP transactions.

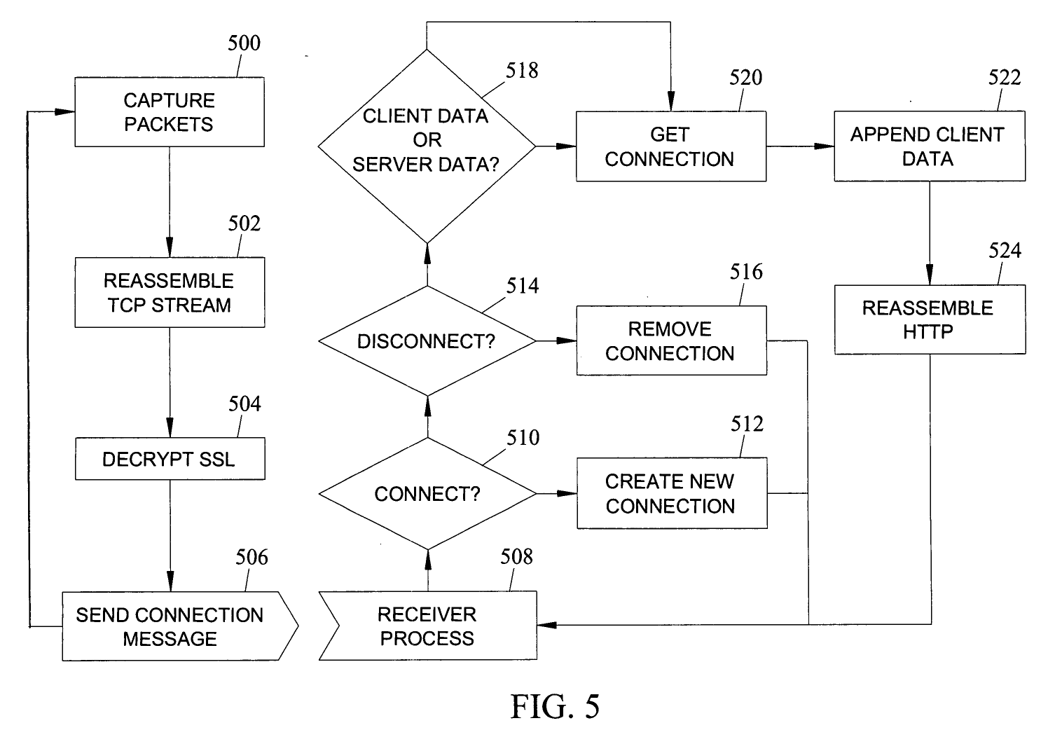

FIG. 5 is a flow chart of exemplary processing steps performed by capture engine CE of FIG. 4 according to an embodiment of the subject matter described herein. Referring to FIGS. 1, 4, and 5, in block 500 individual message packets may be captured (or read) from a network interface(s) in an initial state. In one example, the message packets can include communications between user agent UA and server application SA. In block 502, the captured packets can be reassembled into TCP streams. In one example, reassembly engine 402 performs reassembly of the captured packets into TCP streams. Further, in block 504, SSL decryption can be performed as necessary for each packet. In one example, SSL decryption engine SDE performs SSL decryption. These steps result in asynchronous connection-level messages. In block 506, the connection-level messages can be sent to a receiver process 508 operating in a separate thread of execution. Further, after generating messages asynchronously, processing can proceed to block 500 for capture of additional packets.

Receiver process 508 can be configured to dispatch the messages according to type. For example, receiver process 508 may determine whether a message is a CONNECT message (block 510). If it is determined that the message is a CONNECT message, the message can be dispatched to create a new connection (block 512). In another example, receiver process 508 may determine whether a message is a DISCONNECT message (block 514). If it is determined that the message is a DISCONNECT message, the message can be dispatched to remove connection (block 516). In another example, receiver process 508 may determine whether a message is a CLIENT DATA message or a SERVER DATA message (block 518). If it is determined that the message is a CLIENT DATA message or a SERVER DATA message, the message can be dispatched to get connection for retrieving the connection state associated with the client or server data (block 520). The additional data for the connection can be appended to a growable buffer (block 522). Further, the completely reassembled TCP stream data can be passed to HTTP reassembly engine HRE for HTTP reassembly (block 524).

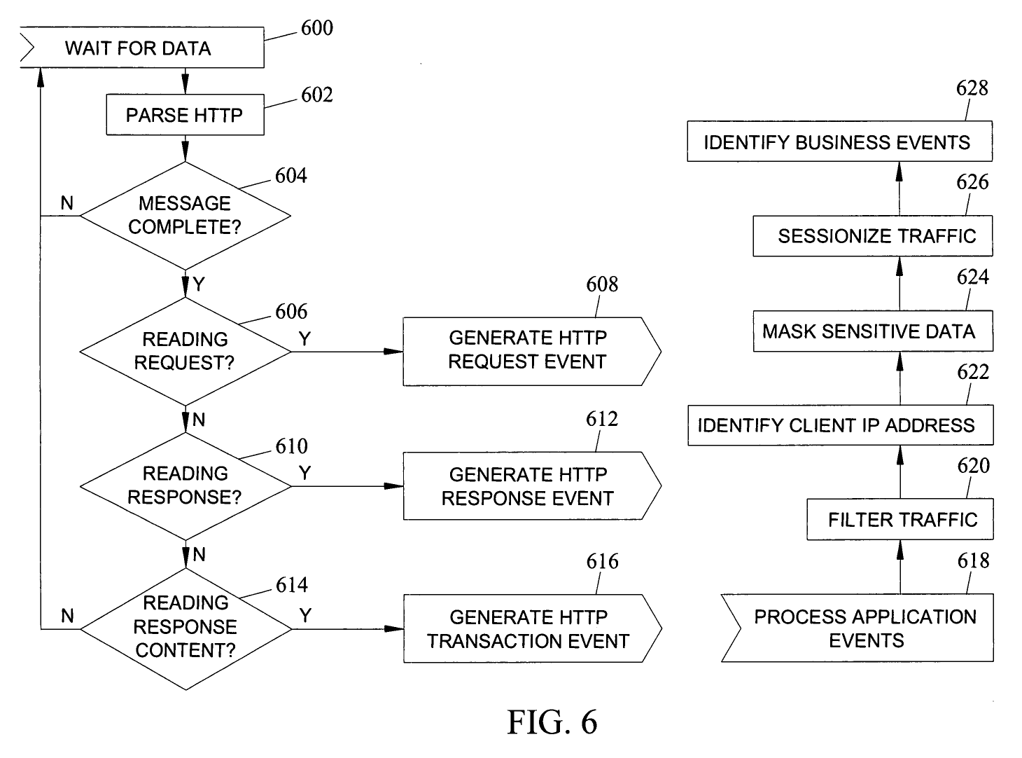

FIG. 6 is a flow chart of exemplary processing steps performed by HTTP reassembly engine HRE of FIG. 4 according to an embodiment of the subject matter described herein. Referring to FIGS. 4 and 6, in block 600 reassembly engine HRE can wait for decrypted packet data. The data can be received via one or more connections and appended to a buffer corresponding to each connection. In block 602, reassembly engine HRE can parse the data into HTTP protocol messages between clients and servers. Various other types of protocols can also be parsed.

In block 604, reassembly engine HRE can determine whether a complete application level message has been received. If it is determined that a complete application level message has not been received, the process can return to block 600 where additional packet data may be received to complete the application level message. If it is determined that a complete application level message has been received, reassembly engine HRE can use a state machine to follow the conversation between clients and servers and determine at any time whether it is reading a request from a client or a response from a server. At block 606, it is determined whether the completed HTTP message is a client request. If it is determined that the completed HTTP message is a client request at block 606, a new HTTP Request event is generated asynchronously (block 608). If it is determined that the completed HTTP message is not a client request, the process can proceed to block 610. At block 610, it is determined whether the completed HTTP message is a response message. If it is determined that the completed HTTP message is a response message at block 610, a new HTTP Response event is generated asynchronously (block 612). The process can then proceed to block 614.

In block 614, the HTTP response content (i.e., the HTTP entity body portion of the message) can be read separately and an independent event can be generated. If the completed response content is available, a new HTTP Transaction event can be generated at block 616. Generating real-time events on separate aspects of the HTTP conversation allows system 100 to deliver real-time information about requests to backend systems without first having to wait for a response, and to deliver real-time information about responses to backend systems without having to first wait for full content to be transmitted back to the client. As described in further detail herein, in a separate thread of execution, the generated event data can be processed by transformation engine TE (shown in FIG. 2).

As set forth above, application protocol events and business-level events can be identified based on IP network traffic. In one example, a business-level event can be identified based on a sequence of client-server exchanges that collectively represent a business-level transaction. In this example, the sequence of client-server exchanges can be correlated to an application session of a user. In another example, identifying an application protocol event or a business-level event can include filtering IP network traffic based on protocol characteristics. In one example, an application protocol event and/or a business-level event can be identified based on application client-server exchanges from a plurality of clients to and from a plurality of application servers.

Identified application protocol events and business-level events can be stored. In one example, the identified events can be recorded as a log file on a file system. For example, the log file can be on a local file system or a remote file system. A remote file system can be accessed as a file share using server message block (SMB)/common Internet file system (CIFS) protocol. Alternatively, a remote file system can be accessed using network file system (NFS) protocol.

### Transformation Engine

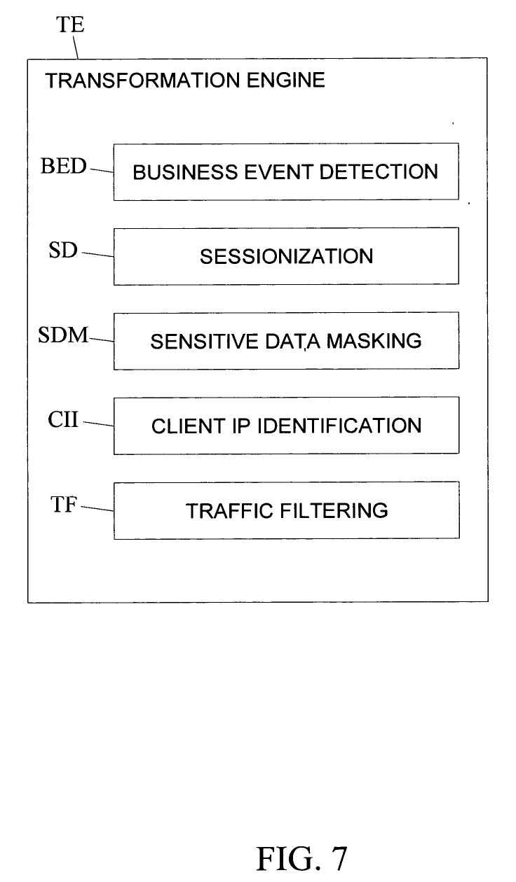

Transformation engine TE can be operable to prepare, select, and augment event data received from capture engine CE and operable to generate additional composite events that can be passed to the feed engine FE. FIG. 7 is a block diagram illustrating exemplary details of transformation engine TE according to an embodiment of the subject matter described herein. Referring to FIG. 7, transformation engine TE can include a traffic filtering module TF configured to filter traffic data. A client IP identification module CII can accurately identify client IP addresses. A sensitive data masking module SDM can mask sensitive data. A sessionization module SM can sessionize traffic data. A business event detection module BED can detect business level events.

As set forth above, transformation engine TE can implement a thread for processing event data generated by capture engine CE. Referring to FIG. 6, an exemplary process of the thread begins at block 618 where application level event data is received from capture engine CE. The application level event data can be processed at block 618 for filtering application traffic that is not to be subject to further processing. As a result, there is a significant data reduction in producing meaningful events and attributes from raw network traffic. In block 620, traffic filtering module TF can filter out these elements based on wildcard matching of the Request-URI, the HTTP/1.1 Host header of the request, or the content type of the response content. In one example, the content type of responses can be determined from the HTTP Content-Type header in the response. In another example, the content type can be determined based on the file extension portion of the Request-URI. In another example, the content type can be stored for Request-URI by CTF based previous access.

In block 622, client IP identification module CII can identify the IP address of the client based on the unfiltered traffic data. In some scenarios, a user can access an Internet facing application via a proxy, in which case the TCP client IP address does not accurately reflect the user's IP address. The proxy can include an HTTP header in the request named X-FORWARDED-FOR that indicates the user's IP address. Reverse proxies and load balancers may use proprietary headers to indicate the same information, and the operator may configure this by changing the “Proxy Header Name” field. Because the value of X-FORWARDED-FOR can be spoofed, a table of trusted proxies can be provided to indicate to system 102 when it is to reply on the value of X-FORWARDED-FOR. If the TCP IP address of the proxy is found in the table then a value specified for X-FORWARDED-FOR will be used as the user's IP address. The resulting IP address is supplied to backend systems via output pumps, and is also used to lookup geolocation information. Accurate geolocation information, which is based on accurate identification of the client IP address, can be important for fraud detection and web analytics applications.

In block 624, sensitive data masking module SDM can mask sensitive data. In particular, characters in HTTP requests can be hidden by replacing them with the character ‘X’. The original characters are overwritten and cannot be recovered at any point in the system forward of this process. This capability is important because HTTP Requests can contain non-public personal information (NPPI) that is not to be retained or made available to backend systems. User passwords and credit card CVV numbers may be examples of such sensitive information. Sensitive information is identified by the names of request parameters and using wildcard patterns to match Request-URIs that may contain those parameters. The sensitive data matching can also be applied to all incoming HTTP requests regardless of the Request-URI. Request parameters include both query arguments and posted form data.

In block 626, sessionization module 626 can perform sessionization of traffic, which is described in more detail herein. Further, in block 628, business event detection module BED can detect business events from the application traffic data.

### Sessionization

Sessionization can be used to identify transactions from a given User-Agent. Further, sessionization can be important for correlating a user's application activity and for distinguishing among multiple users that share the same IP address. Typically, server applications perform session management using session identifiers to hold state information for each client. Session identifiers may be passed between from server to client and from client to server using query arguments, cookies, path parameters in URLs, FORM data, or URL path components. A system in accordance with the subject matter described herein can track sessions based on HTTP authentication information as used with HTTP Basic, Digest, and Microsoft NTLM authentication. Because session identifiers may be found in incoming requests, outbound responses, and even outbound content, a system in accordance with the subject matter described herein can process each of these independently.

In one example, a system in accordance with the subject matter described herein provides two stages of sessionization. First, session tracking makes use of any application generated session identifiers in addition to IP address based information to track user sessions and provide the application generated session identifiers to backend analytical systems. A single, common interface to this information is provided regardless of the number or actual mechanisms used by the application to manage sessions. The second stage of sessionization builds on session tracking and enables the system to run a virtual session manager that generates globally unique session identifiers that backend analytical systems can reference, and provides state information within the system to detect stateful business events that may span multiple transactions within a user session. The virtual session manager creates session state objects that have the same lifetime as sessions within the monitored application.

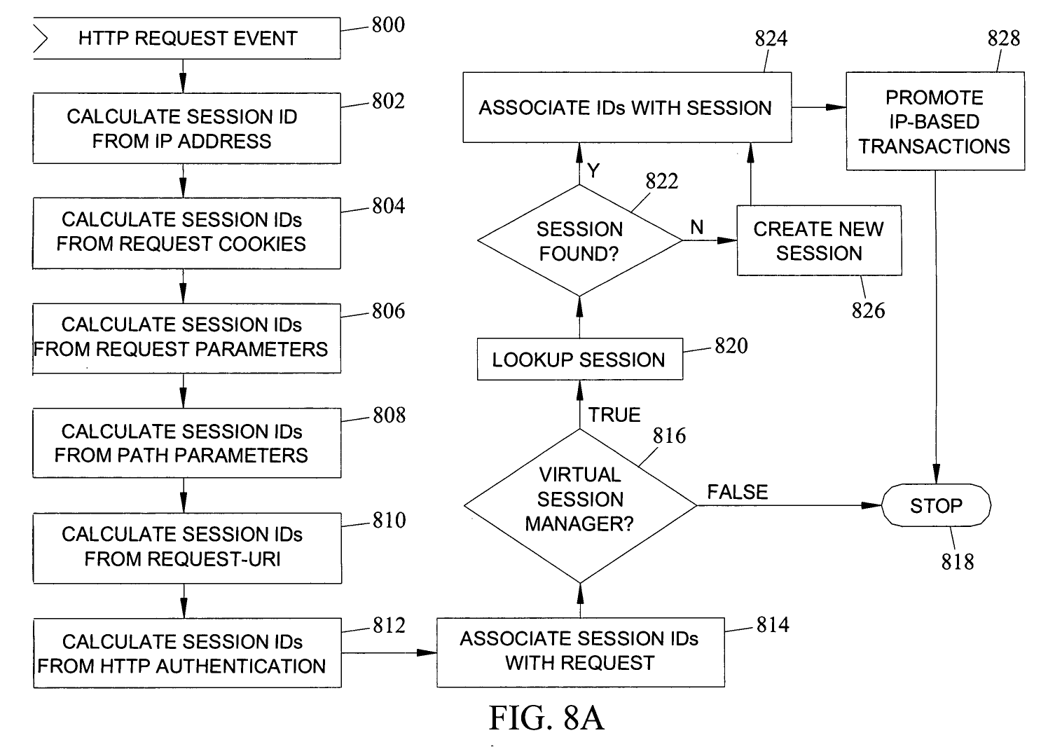

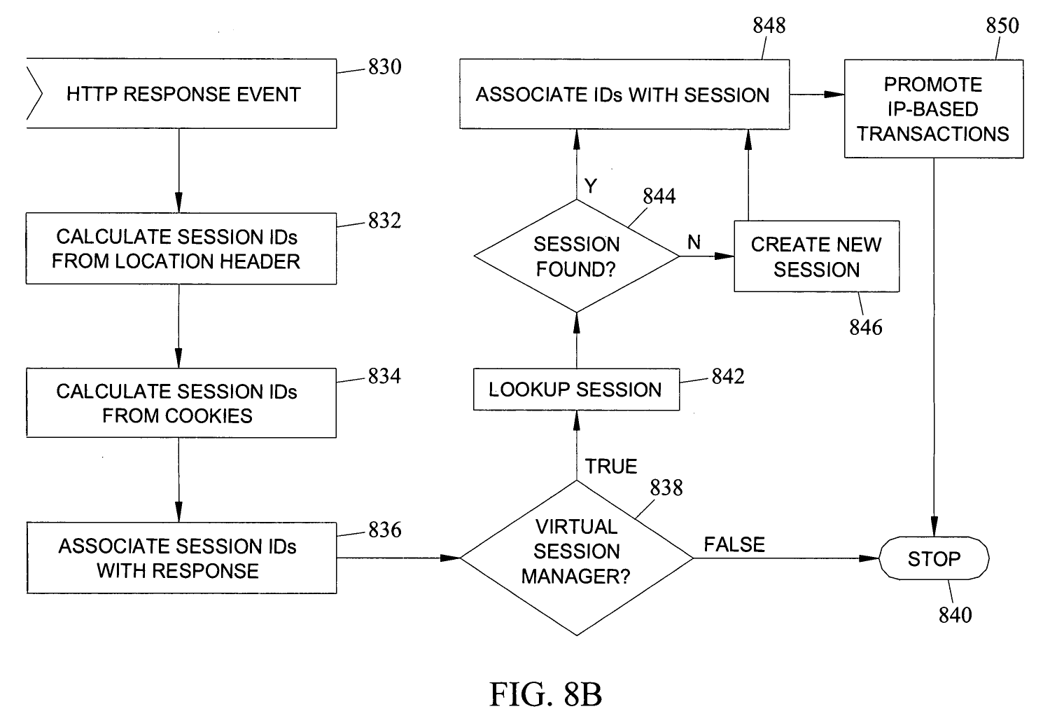

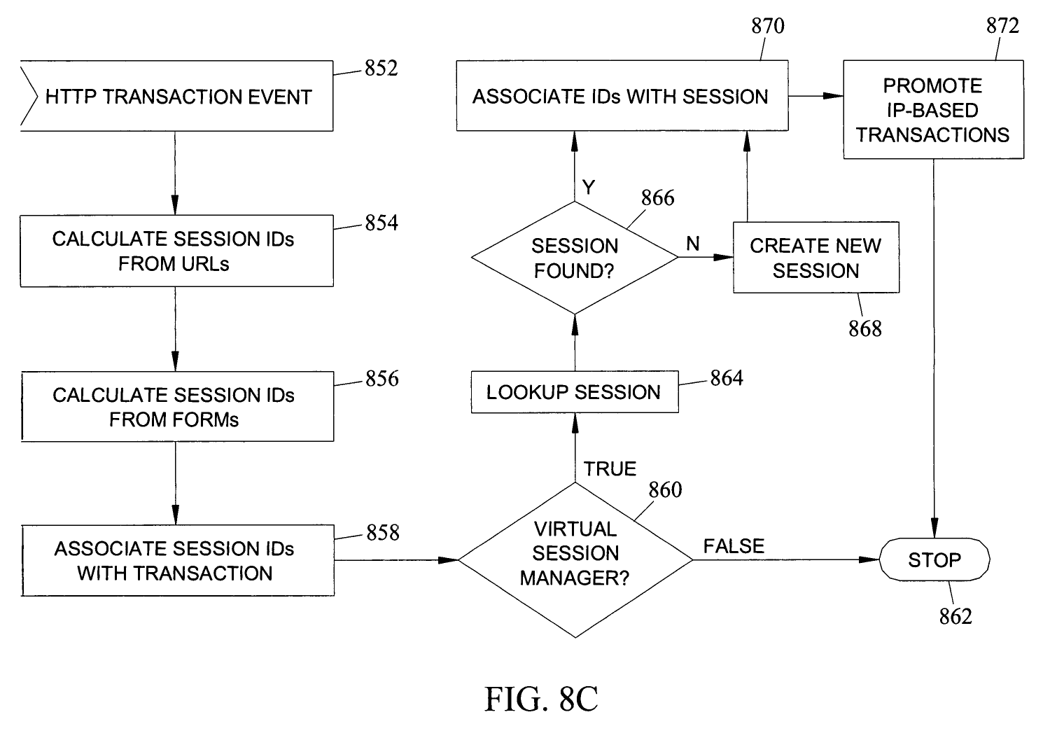

FIGS. 8A, 8B, and 8C are flow charts illustrating exemplary processes of traffic sessionization according to an embodiment of the subject matter described herein. Referring to FIG. 8A, this flow chart shows the details of block 626 shown in FIG. 6 in the scenario of processing an HTTP Request event. The steps of this process can be performed by sessionization module SM shown in FIG. 7. The process can begin when an HTTP Request event is generated at block 800. In step 802, a session ID can be calculated from an IP address of a client. The value of the session ID can be the IP address. Alternatively, the value of the session ID can be augmented with additional identifying information for the client such as the HTTP User-Agent header.

In block 804, session identifiers carried by incoming request cookies are calculated. In block 806, session identifiers carried by request parameters are calculated. Request parameters can include query arguments in URLs and posted form data. In step 808, session identifiers carried by path parameters are calculated. In step 810, session identifiers carried in the path part of the Request-URI are calculated from a regular expression supplied by the operator. In step 812, a session identifier can be calculated from HTTP authentication information. The session identifier can include the user name or the user name augmented with additional identifying information such as the IP address of the client. In step 814, the set of session identifiers calculated from the previous steps are associated with the HTTP request event. As a result of this association, this information can be supplied to backend analytical systems.

In block 816, it can be determined whether system 102 is running a virtual session manager. If it is determined that system 102 is not running a virtual session manager, the process stops at block 818. Otherwise, if it is determined that system 102 is running a virtual session manager, the set of session identifiers associated with the request is used to look up an existing session object (block 820). In block 822, it is determined whether an existing session object is found. If an existing session object is found, the session is updated to include any new session identifiers based on those associated with the request (block 824). The session can always maintain the set of unique session identifiers that either the client or server has used to reference this session. If an existing session is not found, clients are allowed to create a permissive session, in which a new session object is created and likewise updated in block 826. A permissive session is one for which client-supplied session identifiers have not been issued by the server application.

In block 828, a decision is made based on configuration whether to consider transactions that had only an IP address based session identifier (as calculated by block 802) as part of this session. This decision can provide flexibility to the operator to choose how certain HTTP requests will be handled that do not supply the session identifier that the server application has issued. System 102 can operate in the following modes of promotion:
(1) No promotion—transactions with only IP-based session identifiers are never considered part of an application session and are instead grouped within their own separate session;
(2) Continuous promotion—transactions with only IP-based session identifiers are always considered part of an application session, where only one application session at a time is associated with a given IP-based session identifier;
(3) Client promotion—at the time a client first returns an application session identifier to the server, all previous IP-based transactions within a certain time limit are considered part of that session, and subsequent IP-based transactions will be treated like the case for No promotion; and
(4) Server promotion—at the time a server first issues an application session identifier to the client, all previous IP-based transactions will be treated like the case for No promotion.

FIG. 8B shows the details of block 626 shown in FIG. 6 in the scenario of processing an HTTP Response event. The steps of this process can be performed by sessionization module SM shown in FIG. 7. Referring to FIG. 8B, the process can begin when an HTTP Response event is received asynchronously (block 830). In block 832, the HTTP Location header of the response, if present, can be processed to determine whether any application session identifiers are encoded within the URL. In block 834, outbound cookies, which can be found in HTTP Set-Cookie headers, are used to compute outbound application session identifiers. The resulting set of application session identifiers can be associated with this response event (block 836). This information can be made available to backend analytical systems.

In block 838, it can be determined whether system 102 is running a virtual session manager. If it is determined that system 102 is not running a virtual session manager, the process stops at block 840. Otherwise, if it is determined that system 102 is running a virtual session manager, the set of session identifiers associated with these application session identifiers is retrieved and used to look up an existing session object (block 842). In block 844, it is determined whether an existing session object is found. If it is determined that the session object is not found, a new session object can be created (block 846). New application session identifiers can be associated with this session in block 848 for use in referring to this session in future HTTP requests.

In block 850, a decision is made based on configuration whether to consider transactions that had only an IP address based session identifier (as calculated by block 802 in FIG. 8A) as part of this session. If system 102 is configured to perform server promotion and this session is newly created, then all previous IP-based transactions within a certain time limit can be considered as belonging to the new session.

FIG. 8A shows details of exemplary processing of an HTTP transaction event by sessionization module SM shown in FIG. 7 in block 626 shown in FIG. 6 according to an embodiment of the subject matter described herein. In addition to computing outbound application session identifiers from aspects of the HTTP response, system 102 can compute session identifiers from actual content returned to the client. Session identifiers can be found within URLs (referred to as “URL rewriting” or “fat URLs”) and within hidden FORM fields in HTML. Referring to FIG. 8C, the process can begin when an HTTP transaction event is received asynchronously in block 852. System 102 can determine from configured settings and the set of session identifiers seen in the response for this transaction whether it is to examine the content. In block 854, session IDs can be calculated based on URLs. In particular, the HTML response content is examined for URLs and for each URL found outbound session identifiers can be calculated, if present.

In block 856, session IDs can be calculated based on FORMs. In particular, the outbound HTML can be examined for FORMs and, based on examined configuration settings, the presence of outbound session identifiers in fields with the FORM can be determined. The resulting set of application session IDs can be associated with this transaction event (block 858). These steps allow this information to be made available to backend analytical systems.

In block 860, it can be determined whether system 102 is running a virtual session manager. If it is determined that system 102 is not running a virtual session manager, the process stops at block 862. Otherwise, if it is determined that system 102 is running a virtual session manager, an existing session associated with these application session identifiers is retrieved and used to look up an existing session object (block 864). In block 866, it is determined whether an existing session object is found. If it is determined that the session object is not found, a new session object can be created (block 868). New application session identifiers can be associated with this session in block 870 so that they can be used to refer to this session in future HTTP requests.

In block 872, a decision is made based on configuration whether to consider transactions that had only an IP address based session identifier (as calculated by block 802 in FIG. 8A) as part of this session. If system 102 is configured to perform server promotion and this session is newly created, then all previous IP-based transactions within a certain time limit will be considered as belonging to the new session.

### Business Level Events

After sessionization by sessionization module SM shown in FIG. 7, business level events in the application traffic data can be detected by business event detection module BED. Business-level events represent the higher-level actions performed by users via the online application. Exemplary business-level events include open new account, transfer money, order checks, add item to shopping cart, or finalize purchase. System 102 shown in FIG. 1 is configured to recognize business-level events within the stream of application traffic and distill just the relevant attributes of the business-level events. Business-level events can then be processed, along with application protocol events, by the feed engine FE shown in FIG. 2.

Business events can be simple or complex. Simple business events include events that correspond to and are fully determined by a single HTTP transaction. Complex business events may be triggered from a defined sequence of HTTP transactions within a stateful session. System 102 can build complex business events from a sequence of related simple business events.

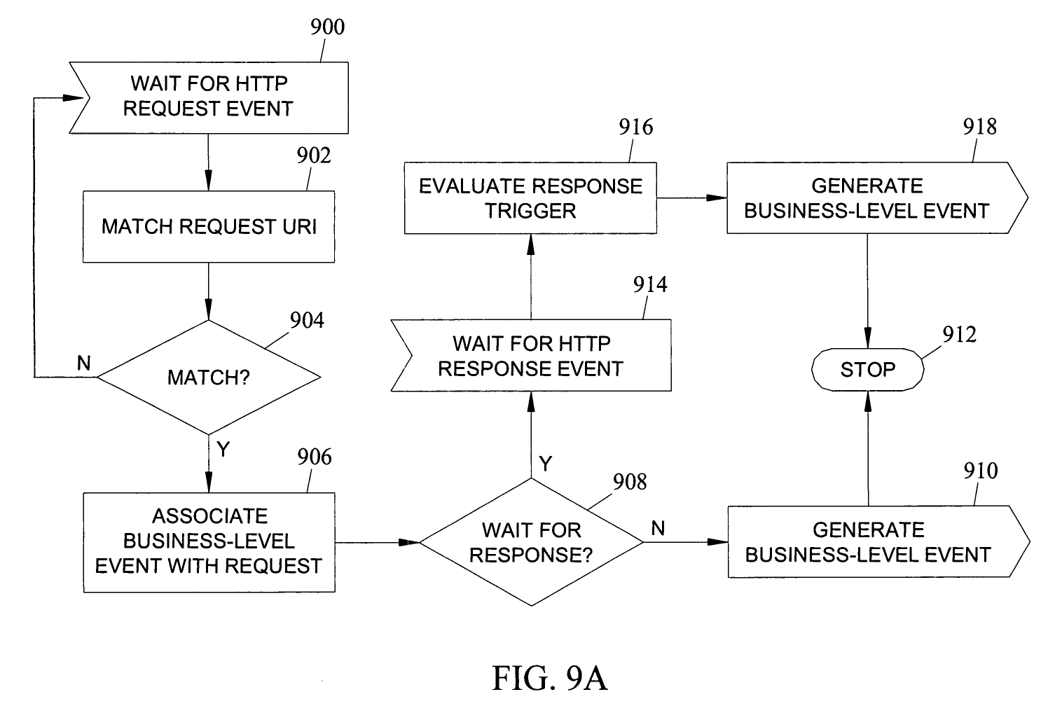

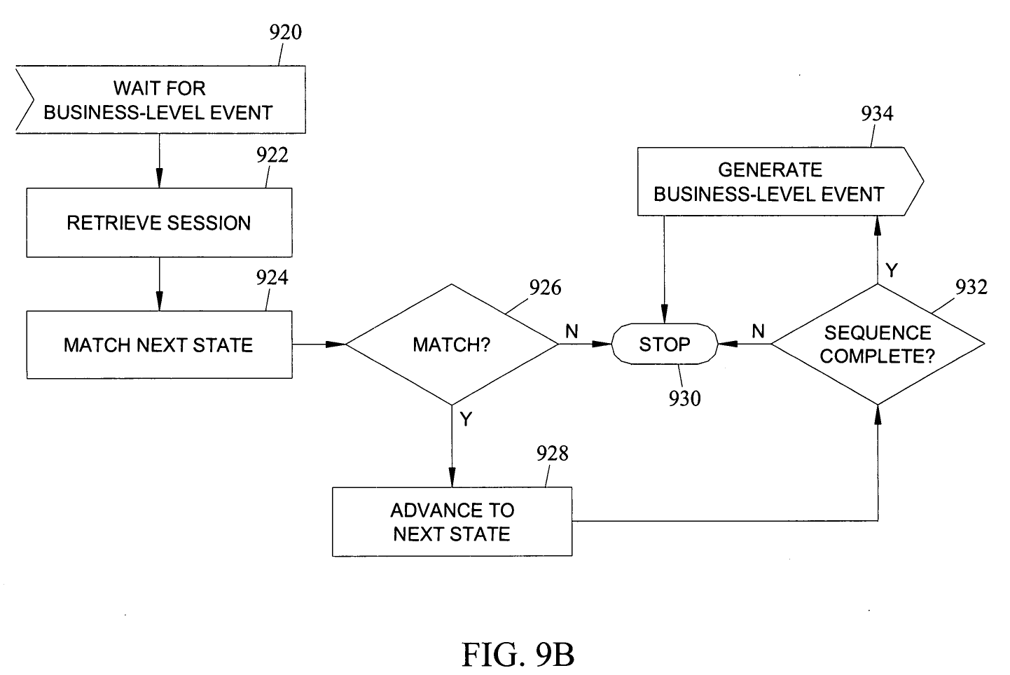

FIG. 9A is a flow chart illustrating an exemplary process for generating simple business-level event data based on individual HTTP transactions according to an embodiment of the subject matter described herein. The process can be implemented by business event detection module BED shown in FIG. 7. Referring to FIG. 9A, the process can begin when an HTTP request event is determined at block 900. System 102 can generate a business-level event based solely on aspects of the HTTP request, without waiting for the server's HTTP response. Alternatively, system 102 can generate business-level events using aspects of the both the HTTP request and the HTTP response. This capability is important to generate events in real-time for backend systems that are to analyze and take action as soon as user activity is seen without first having to wait for the server application to completely process the user activity. In one example, module BED can asynchronously receive HTTP request events at block 900.

In block 902, the Request-URI is examined for matches against a wildcard pattern defined for each business event. Wildcard matching can include aspects of the URI and/or testing for the presence and values of request parameters. Request parameters can include both query arguments and posted form data. In block 904, module BED can determine whether the request matches. If it is determined that the request matches, the request event is associated with the business-level event (block 906). Otherwise, if it is determined that the request does not match, the process can return to block 900. This step allows backend analytical systems to learn, filter, and correlate activity based on business events.

Based on configuration for each business-level event, the characteristics of the HTTP request can completely define the event and it can be generated immediately. The generation of the event can happen before the server application has seen or fulfilled the HTTP request. For example, in block 908, it can be determined whether to wait for an HTTP response to the HTTP request based on the HTTP request. An HTTP response may be needed if the response from the server application is needed to characterize and event. If it is determined not to wait for the HTTP response, a business-level event can be generated (block 910) and the process can stop (block 912). As a result, it is determined that the identified event only includes client response data, and therefore the information associated with the identified event is delivered to the backend system before receiving a server response to the client request. Otherwise, if it is determined to wait for the HTTP response, system 102 can wait for the HTTP response (block 914). In block 916, the response and the response content can be evaluated to determine whether the business-level event has occurred and to extract important information from the response content that are to be associated with the event. Any information extracted in this way can also be available to backend systems to analyze. Finally, the completed business event can be generated (block 918).

FIG. 9B is a flow chart illustrating an exemplary process for generating complex business-level events from a sequence of simple business-level events within a user session according to an embodiment of the subject matter described herein. Referring to FIG. 9B, in block 920 business-level events can be asynchronously received. The business-level events can be simple or complex events. For each event, the stateful session object associated with the event can be retrieved (block 922). The-session object stores the state information for each complex business that is to be evaluated as a sequence of user activity in the online application.

In block 924, the current state for this session is compared to a sequence defined for each complex business event for matching the next state. In block 926, it is determined whether the next state matches. If it is determined that the current event matches the next-required state for any complex business event in block 926, the session state machine advances to the next state for that complex business event (block 928). Otherwise, if it is determined that the current event does not match the next-required state, the process stops at block 930.

In block 932, it is determined whether the sequence has been fully completed. If it is determined that the sequence has been fully completed, a complex business-level event can be generated (block 934). The resulting event has accumulated all of the relevant attributes of the complex business event gathered at each step in the sequence and this information can be made available to backend analytical systems.

### Output Pumps

Feed engine FE shown in FIG. 2 can capture and transform events to define and route them to backend analytical system in an appropriate usable format and by use of suitable communication protocol. System 1.02 can include output pumps that feed information over TCP connections as comma separated values or XML, pumps that deliver messages over an enterprise message bus using Java messaging service (JMS) interfaces, pumps that record captured and transformed events directly to log files via network attached storage (NAS) or storage attached networks (SAN), and pumps that translate captured and transformed events into row inserts in a database using Java database connectivity (JDBC) interfaces. JMS (Java Messaging Service) is a specification that allows Java programs to interoperate with enterprise message bus providers using a standard interface from within Java. JDBC (Java database connectivity) is a specification that allows Java programs to interoperate with relational database providers using a standard interface from within Java.

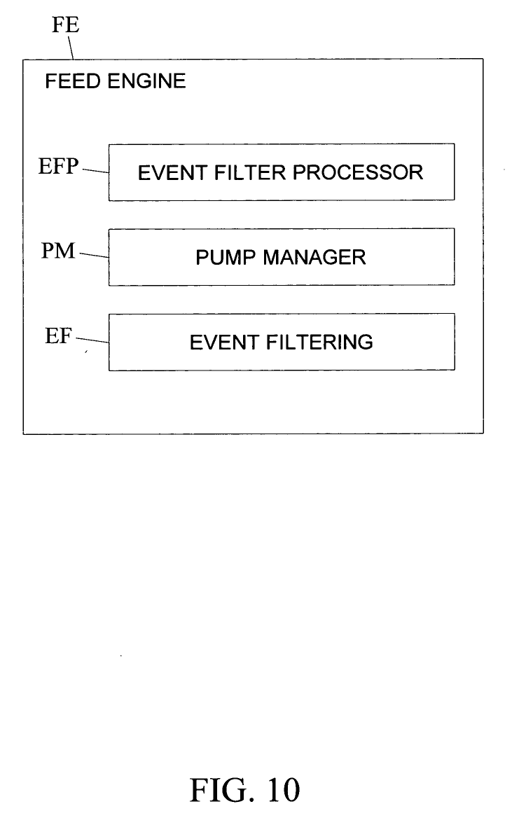

FIG. 10 is a block diagram illustrating exemplary details of feed engine FE shown in FIG. 2 according to an embodiment of the subject matter described herein. Referring to FIG. 10, a pump manager PM can create and manage output pumps. Pumps are plugin modules that can be installed, uninstalled, enabled, disabled, and configured during live operation of system 102. An event processor EP can route generated application protocol and business-level events to each running pump based on configuration. In addition to specific configuration for each pump, pumps can have an individual event filter processor EFP running for controlling which events are fed to a backend system through the pump. Application protocol events can be filtered based on Request-URI, HTTP Host header, presence and values of request parameters, or based on the content type of the response. Business-level events may be filtered based on the name assigned to the business-level event or the values of attributes assigned to the business-level event.

The pumps can use common expression syntax for mapping attributes of HTTP requests and responses to the output attributes of generated events. In this way, an operator can define, and change at any time, the exact information that is captured and fed into a backend analytical system or recorded in a log file.

In accordance with the subject matter described herein, the feeding of transformed data to a backend system includes feeding transformed data including a selected and interpreted subset of the data present in the network traffic and information derived from the data in the network traffic.

In one example, the transformed data can be fed using a suitable protocol. For example, the transformed data can be fed to a backend system using user datagram protocol (UDP) connections. In another example, the transformed data can be fed to a backend system using system log (SYSLOG) protocol.

### Extractors

In scenarios where the content format of the output from a pump is based on attributes of application protocol events, system 102 can use the following exemplary syntax (using BNF notation):

(extractor|text)+Where extractor=“%”[“{”parameter “}”] function

The available functions can include the following:

Functions

| Function | Meaning |
|---|---|
| % a | Client IP-address as dotted quad |
| % A | Server IP-address as dotted quad |
| % B | Size of response in bytes, excluding HTTP headers. |
| % b | Size of response in bytes, excluding HTTP headers. |
| | In common logging format (CLF) |
| % {name}c | The value of the cookie “name” in the request sent to |
| | the server. |
| % c | All request cookies as name = value[;name = value]* |
| % {name}C | The value of the cookie “name” in the response |
| % C | All response cookies as name = value[;name = value]* |
| % D | The time taken to serve the request, in milliseconds. |
| % f | The filename part of the request URI |
| % {format}F | Specifies a format to use for subsequent output |
| % {format}g | Geolocation information of the client |
| | Where format is |
| | c - Country code |
| | n - Country name |
| | r - Region |
| | y - City |
| | o - Longitude |
| | a - Latitude |
| | p - ISP |
| | q - Organization |
| % G | Virtual session identifier based on client IP address |
| % h | The fully qualified domain name of the remote host |
| % H | The request protocol, e.g. “http” or “https” |
| % {name}i | The value(s) of the HTTP request header “name” |
| % l | Bytes received, including request and headers |
| % m | The HTTP request method, e.g. “POST” |
| % M | The pattern matches associated with the business |
| | event |
| % {index}M | The specific results of pattern matches associated |
| | with the business event based on an index lookup |
| % {delimiter}M | The specific results of pattern matches associated |
| | with the business event using the specified delimiter |
| % {name}o | The value(s) of the HTTP response header “name” |
| % O | Bytes sent, including headers. |
| % p | The TCP port of the server serving the request |
| % q | The query string (prepended with a ? if a query string |
| | exists, otherwise an empty string) |
| % r | First line of request (i.e. the HTTP request line) |
| % R | All request parameters formatted as a form-url- |
| | encoded string (includes posted form data and query |
| | arguments) |
| % {name}R | The specified request parameter (from posted form |
| | data or query string) |
| % s | The HTTP status code of the response |
| % t | Timestamp of the request in milliseconds since Jan. 1, |
| | 1970 (UTC time) |
| % {format}t | Timestamp of the request, in the specified format |
| % T | The time taken to serve the request, in seconds. |
| % u | The name of the remote user |
| % U | The request URI, not including any query string. |
| % v | Value of the HTTP Host header or the same as % A if |
| | no Host header was sent |
| % w | The name of the business event associated with this |
| | transaction. |
| % x | Globally unique session ID |
| % X | Connection status when response is completed: |
| | X = connection aborted before the response |
| | completed. |
| | + = connection may be kept alive after the |
| | response is sent. |
| | − = connection will be closed after the |
| | response is sent. |
| % Y | Unique transaction ID associated with the request |
| % z | Set of inbound application session identifiers |
| % Z | Set of outbound application session identifiers |

and text=characters or escape sequences.

Escape Sequences

| Sequence | Meaning |
|---|---|
| %% | Percent sign |
| \\ | Backslash |
| \ooo | Octal |
| | character |
| \xhh | Hex character |
| \Xhh | Hex character |
| \b | Bell |
| \f | Formfeed |
| \n | Newline |
| \r | Carriage |
| | return |

### JDBC Database Pump

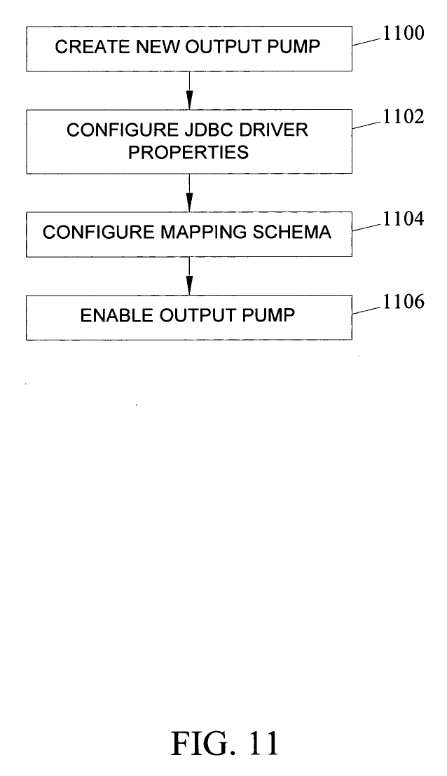

In one example, a JDBC database pump can be utilized with system 102. A JDBC database pump can feed captured and transformed events into a database in real-time using a JDBC interface. FIG. 11 is a flow chart illustrating an exemplary process for using a JDBC database pump according to an embodiment of the subject matter described herein. Referring to FIG. 11, a four-step process can be used to begin inserting configurable captured events from a network as rows in a database table. In block 1100, a new output pump for JDBC can be created. In block 1102, JDBC driver properties can be configured for allowing selection and configuration of a JDBC vendor's provider properties. In block 1104, the operator can define a mapping from events captured and transformed by system 102 to columns in a database table. In block 1106, the new pump can be enabled to and rows inserted into the defined table. The process of FIG. 11 can be performed while system 102 is running in a live network environment.

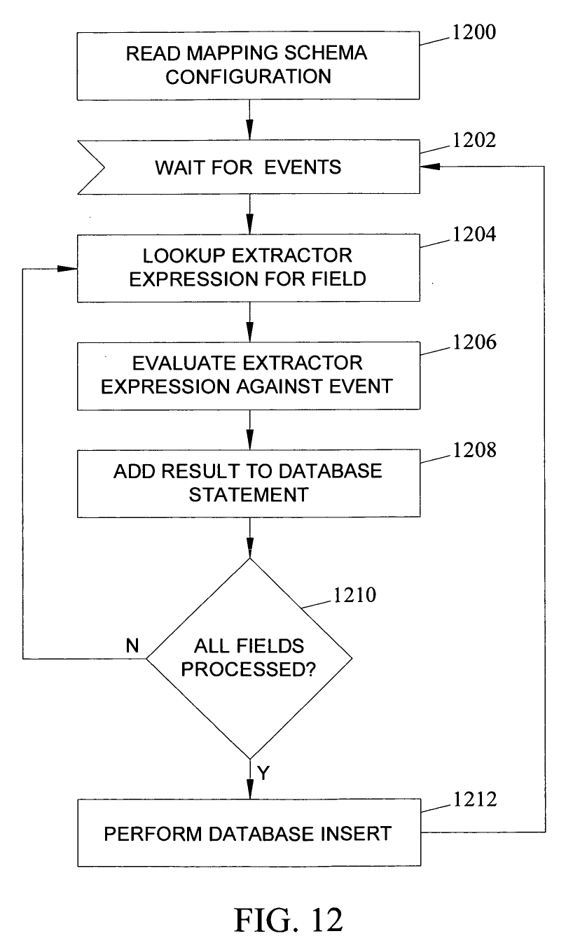

FIG. 12 is an exemplary flow chart illustrating the operation of a JDBC pump according to an embodiment of the subject matter described herein. Referring to FIG. 12, from an initial starting state in block 1200, the configuration information of the pump is read. The configuration information can include a definition of how to populate columns from event attributes for each row that will be inserted into the table. In block 1202, the pump can wait to be notified of new events for feeding into the database. In one example, the step of block 1202 can be under control of the event processor EP shown in FIG. 10.

When an application protocol event or business-level event is received for the pump, a lookup for the extractor expression defined for each field can be performed for insertion into the database (block 1204). In block 1206, the extractor expression can be evaluated against the current event being processed. The resulting value can be assigned to the field (block 1208). In block 1210, it can be determined whether all fields have been processed. If it is determined that all fields have not been processed, the process can return to block 1204 to process the next field. Otherwise, if it is determined that all fields have been processed, the database insert statement has been fully prepared, and the insert operation can be executed against the database using a JDBC interface (block 1212). Next, the process can return to block 1200 to wait for subsequent events.

### Capture Traffic

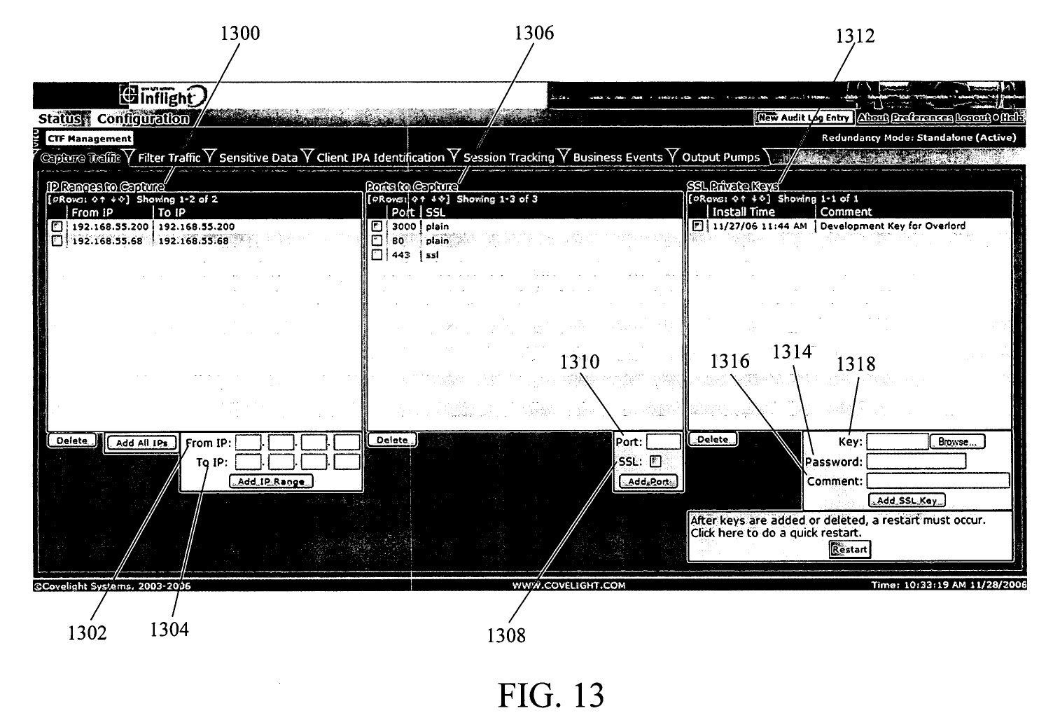

As stated above, a computer workstation can be in communication with system 102. The computer workstation can include a display for displaying activity information about the traffic and events passing through system 102 and for configuring the behavior, parameters, and output pumps of system 102. FIG. 13 shows a screen display of capture traffic configuration presented by a display of a computer workstation according to an embodiment of the subject matter described herein. Referring to FIG. 13, configuration via the screen display can determine what network traffic is captured by system 102 and can enable decryption of SSL traffic. Further, the screen display can present a list of IP Ranges to Capture portion 1300 for allowing a user to enter a range of IP addresses for system 102 to monitor. The user can enter a first IP address in the range at text box 1302 and a last IP address in the range at text box 1304. All network traffic passing to and from server IP addresses within the range can be captured by system 102.

A user can specify TCP ports to monitor for the selected range of IP addresses via the screen display at a List of Ports to Capture portion 1306. Further, the user can specify that traffic on the selected port is encrypted using SSL by checking box SSL 1308 when entering a port value in the input field Port box 1310.

A user can upload server private keys required for SSL decryption at a List SSL Private Keys portion 1312. The user can operationally specify a password in box 1314 and a comment at box 1316 for the required private key file which is specified by the Key input field 1318. System 102 can automatically associate uploaded private keys with the correct server IP address(es). The user can also be presented with additional options to enable support for hardware-based FIPS 140-2 compliant key management.

### Filter Traffic

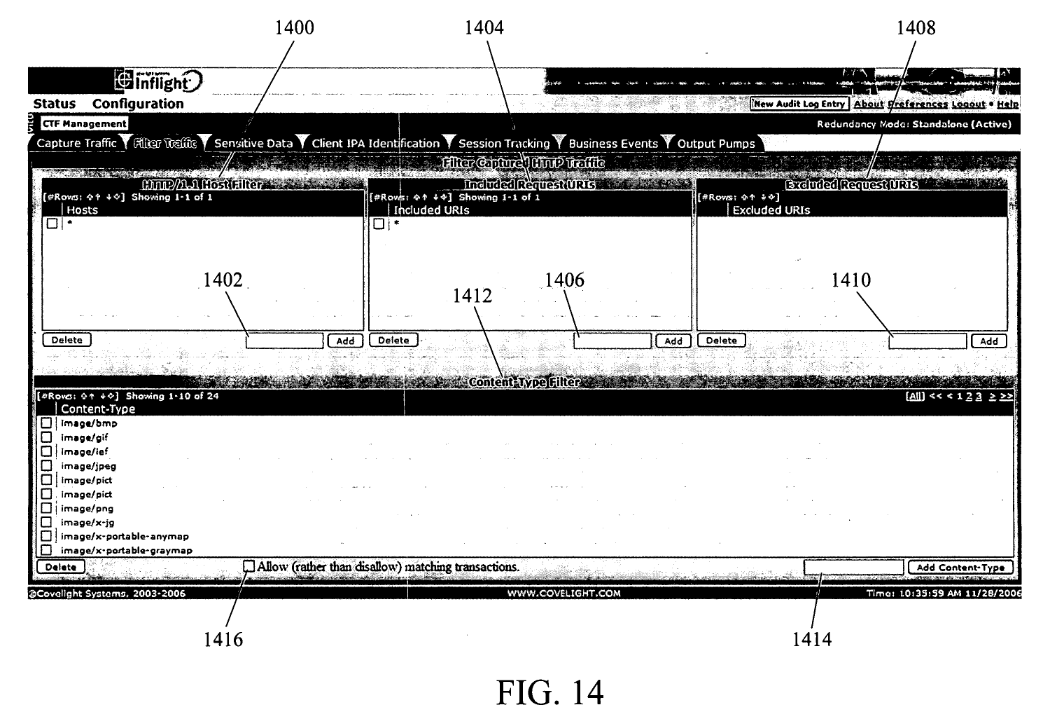

A user can operate a workstation to specify that certain HTTP transactions are captured or filtered out and not processed. FIG. 14 shows a screen display for filtering traffic presented by a display of a computer workstation according to an embodiment of the subject matter described herein. Referring to FIG. 14, the screen display provides an interface for specifying filtering criteria based on values of the HTTP/1.1 Host header in requests using list HTTP/1.1 Host Filter portion 1400. The user can enter acceptable values of the Host header in input field 1402. A value of * (a default value) indicates that any value for the Host header is acceptable.

HTTP requests that are to be processed can be specified based on the Request-URI using list Included Request URIs portion 1404. Additional wildcard patterns can be entered into input field 1406 one at a time. A value of * (a default value) indicates that all HTTP requests are to be processed except those specifically excluded using a list of Excluded Request URIs portion 1408. Wildcard patterns for requests that are to be excluded are entered one at a time into input field 1410.

Further, traffic may also be filtered based on the HTTP Content-Type of the server's response. A list of content types to be included or excluded may be specified using a list of Content Type Filter portion 1412. HTTP Transactions where the HTTP Content-Type of the response, either explicitly specified in the response headers or guessed from the file extension part of the Request-URI, can be filtered out and not processed. Additional content types can be entered one at a time using input field 1414. The meaning of the list can be reversed entirely by checking the Allow box matching transaction 1416.

### Sensitive Data

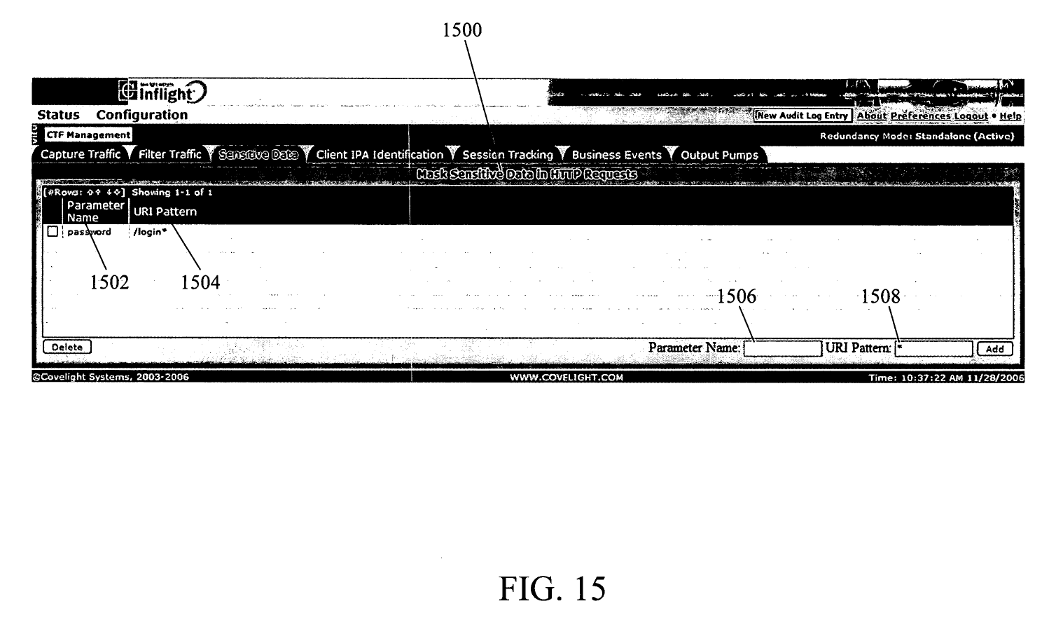

A user can configure masking of sensitive data contained in HTTP requests. FIG. 15 shows a screen display for masking of sensitive data contained in HTTP requests according to an embodiment of the subject matter described herein. Referring to FIG. 15, a list Mask Sensitive in HTTP Requests portion 1500 can allow the user to replace certain characters in HTTP requests with an ‘X’. Sensitive data, such as user passwords, that should not be stored or passed to output pumps, can be specified by their parameter name in a HTTP requests portion 1502. The HTTP requests that are to be examined for these parameters are specified using a wildcard pattern for a Request-URI portion 1504. Additional entries can be created one at a time by entering the request parameter name in input field 1506 and the Request-URI wildcard pattern in input field 1508. For any parameter that matches a specified sensitive parameter, the entire value of the parameter entered by the user can be replaced by a string of ‘X’ characters equal in length to the supplied data.

### Client IPA Identification

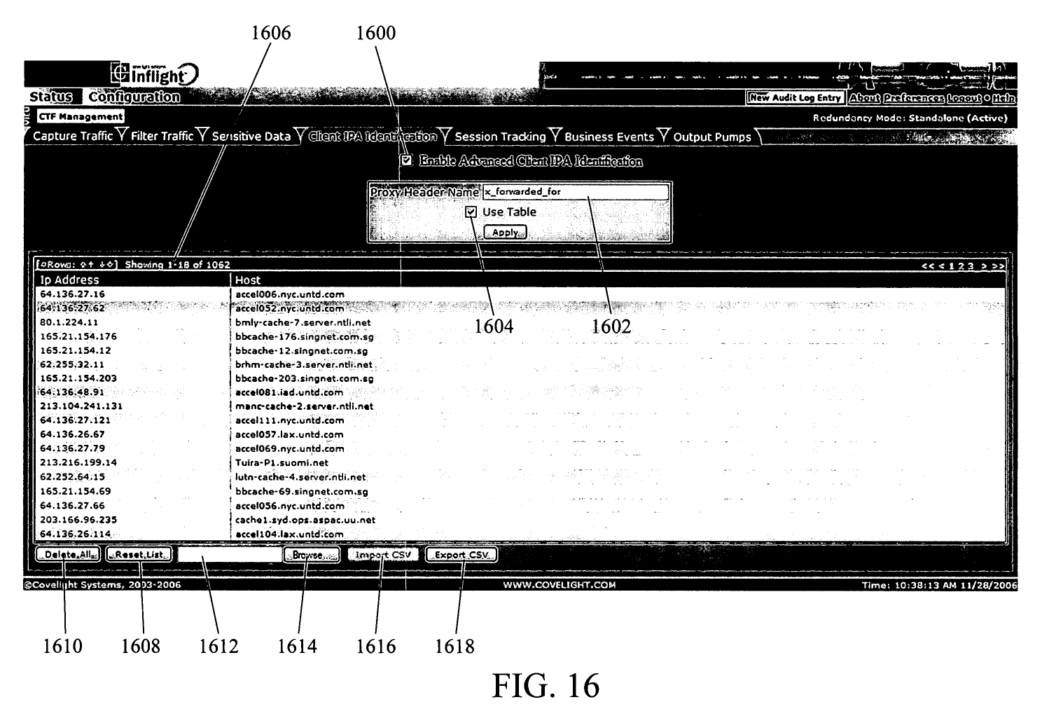

A user can operate a workstation to configure a calculation of a user's IP address when the user accesses the application through a forward or reverse proxy or load balancer. FIG. 16 shows a screen display for use in configuring a calculation of a user's IP address according to an embodiment of the subject matter described herein. Referring to FIG. 16, the user can enable advanced client IP address identification by checking the box 1600. If box 1600 is unchecked, the IP address of the TCP client is used. The user can enter the name of the HTTP header that specifies the client's IP address in input field 1602. The default value can be X-FORWARDED-FOR. Further, the user can check a Use Table box 1604 to specify that the value found in a header can only be accepted if the IP address of the proxy being used is found in table 1606. The table can be reset to default values by pressing Reset All button 1608. The table can be emptied of all values by pressing Delete All button 1610. New values can be entered by preparing a CSV text file and entering the file name in input field 1612, or browsing to the prepared file using button 1614. The specified file can be uploaded by selecting Import CSV button 1616. The specified file can be exported by selecting Export CSV button 1618.

### Session Tracking

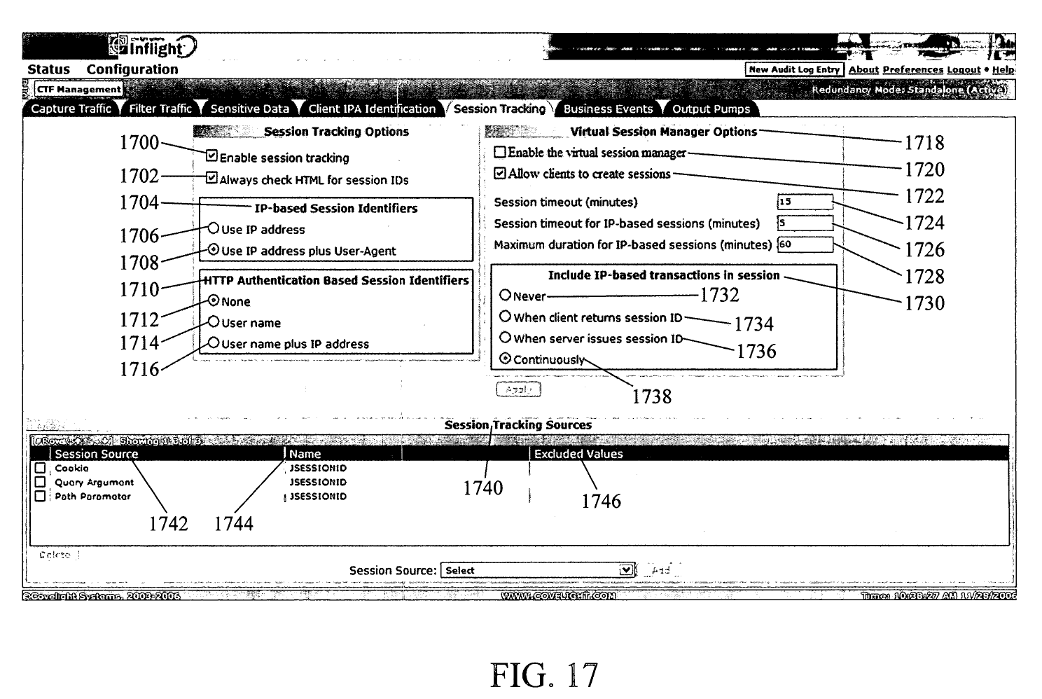

A user can operate a workstation to configure system 102 with information about how the application(s) being monitored manages HTTP sessions. FIG. 17 shows a screen display for use in configuring system 102 with information about how the application(s) being monitored manages HTTP sessions according to an embodiment of the subject matter described herein. Referring to FIG. 17, enable session tracking checkbox 1700 can be checked to enable tracking of user application sessions. Always check HTML for session IDs checkbox 1702 can be checked to inform system 102 to inspect response content for the presence of application session IDs.

When no application-generated session ID is available, system 102 can compute a session ID based on the selection in the IP-based Session Identifiers box 1704. Two possible choices are Use IP address 1706 and Use IP address plus User-Agent 1708.

For applications that make use of HTTP-based authentication, including HTTP Basic, HTTP Digest, and Microsoft NTLM authentication, system 102 can compute a session ID based on authentication information if no application-generated session is available. The choice is determined by the option selected in HTTP Authentication Based Session Identifiers box 1710. Three options include checking either None box 1712 to indicate that the application does not use HTTP based authentication, User Name box 1714, or User name plus IP address box 1716.

Further, the user can activate a virtual session manager that emulates the lifetime and scope of application sessions using the options and settings under Virtual Session Manager Options box 1718. An Enable the virtual session manager box 1720 can be selected to activate the virtual session manager. An Allow clients to create sessions checkbox 1722 can be checked to inform system 102 to recognize session IDs from clients, even if the application server has not previously generated them.

The session timeout value for application sessions can be entered into input field Session timeout field 1724. A separate session timeout for sessions based only on IP addresses can be entered into input field 1726. A maximum allowable duration for such sessions can be entered in field 1728.

Options entered in Include IP-Based Transactions In Session box 1730 can control how system 102 can incorporate HTTP transactions that do not have any application session ID available. The options in box 1730 include (1) Never box 1732, which can be selected such that IP-based transactions are never considered part of the user's session; (2) a client returns session ID box 1734, which can be selected such that all prior IP-based transactions are be considered part of the user's session at the time the client first returns an application generated session ID; (3) a When server issues session ID box 1736, which can be selected such that all prior IP-based transactions are considered part of the user's session at the time the server application first issues an application generated session ID; and (4) Continuously box 1738, which can be selected such that IP-based transactions are always considered part of the user's session.

The specific mechanisms by which the application conveys session IDs is can be configured under Session Tracking Sources table 1740. The table allows the operator to enter multiple mechanisms one at a time. For each, the type of the session source can be specified in a Session Source column 1742. The source types can include Cookies, FORM fields, query arguments, path parameters, and session IDs encoded within the URL path. The specific name of the session source is specified in a Name column 1744. Further, any specific values for this source that are not be recognized as application-generated session IDs can be specified in an Excluded Values column 1746.

### Business Events

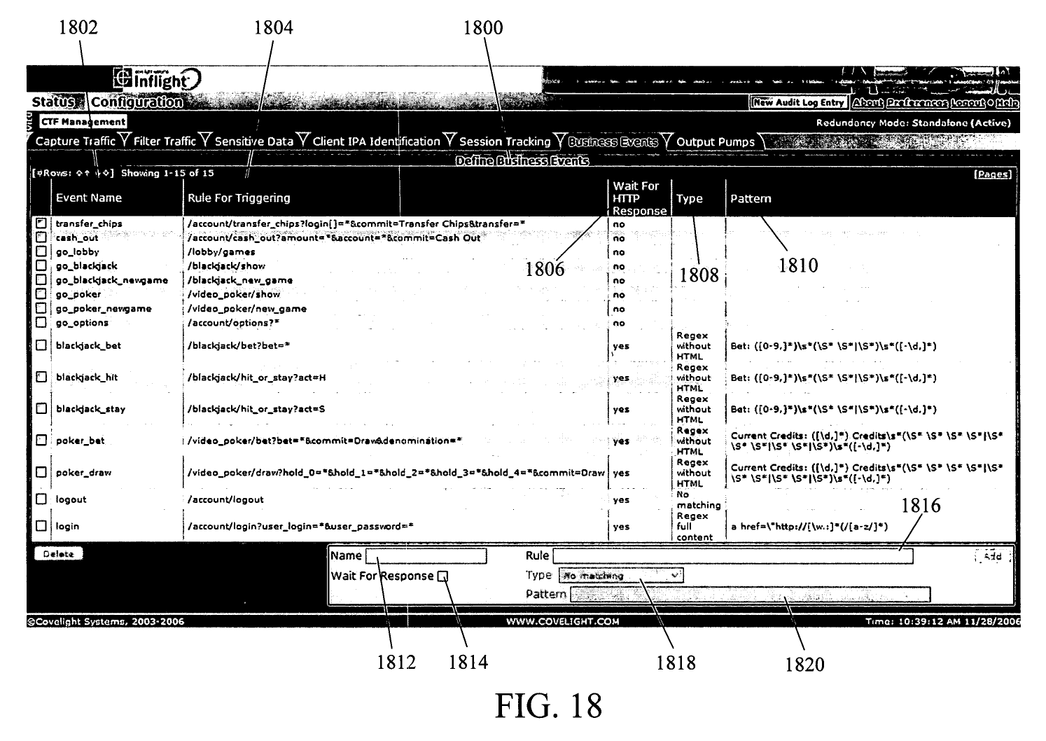

A user can operate a workstation to configure business-level events that system 102 can generate from underlying application traffic. FIG. 18 shows a screen display for use in configuring business-level events that system 102 can generate from underlying application traffic according to an embodiment of the subject matter described herein. Referring to FIG. 18, a Define Business Events table 1800 that configures the business-level events that system 102 can generate from underlying application traffic. Table 1800 includes five columns that define each business event. Event Name column 1802 is the assigned name of this business event. Rule for Triggering column 1804 is the wildcard pattern that matches this event to the Request-URI of HTTP requests. Wait For HTTP Response column 1806 is a yes or no selection that informs system 102 at what point in time the business event is to be generated. A type column 1808 shows what, if any, aspect of the server's response is used to trigger the event. A Pattern column 1810 shows the regular expression or XPath expression that is matched against the response content.

New business events can be added one at a time by entering a name in input field 1812. By checking Wait For Response box 1814, the generation of the business event is delayed until the application server response has been fully received. If box 1814 is not checked, an event can be generated and processed as soon as the HTTP request is received. A rule for triggering the event can be entered in input field 1816. The rule is a wildcard pattern that matches the Request-URI of the HTTP request. If Wait For Response box 1814 is checked, then additional input fields will be available. A Type selection 1818 can be used for allowing an optional condition to be placed on the response content. The options include (1) No matching, which can be entered such that the response does not determine if the event is triggered; (2) Regex without HTML, which can be entered such that a regular expression is matched against the content stripped of all HTML tags; (3) Regex with full content, which can be entered such that a regular expression is evaluated against the full HTML source; and (4) XPath expression, which can be entered such that an XPath expression is evaluated against the HTML source. Input field 1820 allows the regular expression or XPath expression to be entered.

### Output Pumps

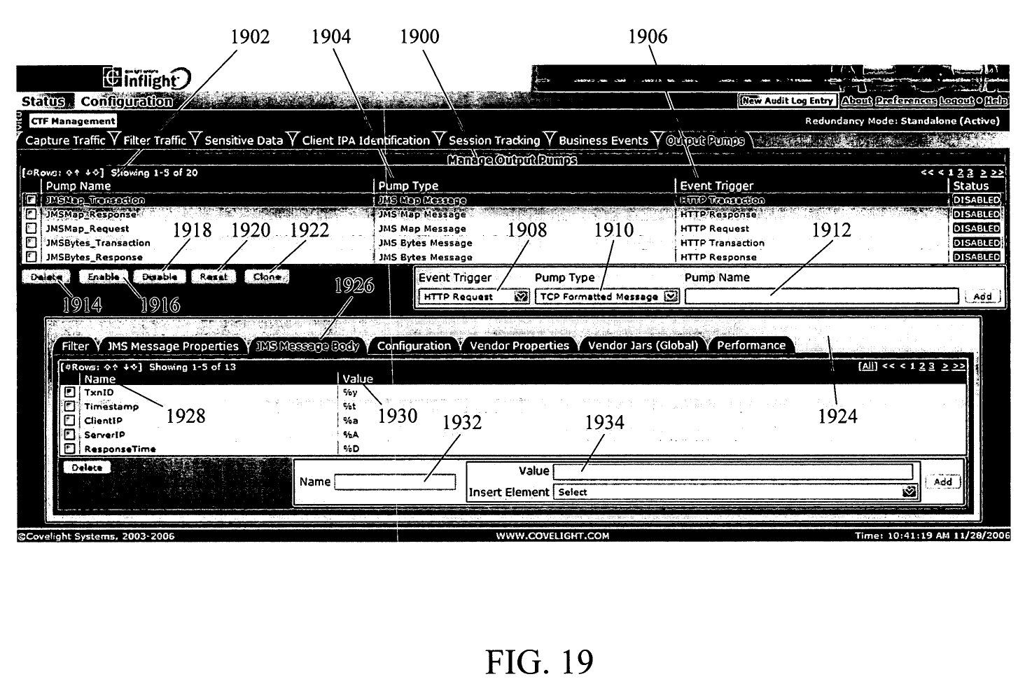

A user can operate a workstation to configure the output feeds generated by system 102. FIG. 19 shows a screen display for use in configuring the output feeds generated by system 102 according to an embodiment of the subject matter described herein. Referring to FIG. 19, a Manage Output Pumps table 1900 includes the installed output pumps and their configuration. Column Pump Name column 1902 shows the name assigned to the pump. Column Pump Type column 1904 shows the type of output pump. Event Trigger column 1906 shows the type of event is being fed through the output pump.

New output pumps can be created by selecting an event trigger using selection box 1908. Event triggers can include HTTP Request, HTTP Response, and Business Events. A Pump Type selection box 1910 can be used for specifying which pump to create from a set of installed pumps. Installed pumps can include TCP Formatted Message, TCP Raw Message, JMS Map Message, JMS Bytes Message, JMS Text Message, SMB Formatted Logs, SMB Raw Logs, JDBS SQL Message. The operator can assign a name to the newly created pump using input field 1912.

Pumps can be managed using button 1914 to remove a pump from CTF; button 1916 to enable a non-running pump; button 1918 to disable a running pump; button 1920 to reset the configuration of a pump to default values; and button 1922 to create a copy of a pump.

Each managed pump can include specific configuration parameters that relate to the operation of the pump. The screen display can include a portion 1924 for a JMS Map Message pump. The pump also incldues configuration to further filter events, specify JMS message properties, and upload vendor client JARS required for JMS connectivity. Configuration tab. 1926 shows that aspects of an HTTP transaction can be mapped onto JMS map message entries. Column 1928 shows the name of a message property that are written into each JMS message generated by system 102 for the pump. Column 1930 shows an expression that selects aspects of the HTTP transaction to be assigned to this map entry. Additional map entries can be created one at a time by entering a name in input field 1932 and an extractor expression in input field 1934.

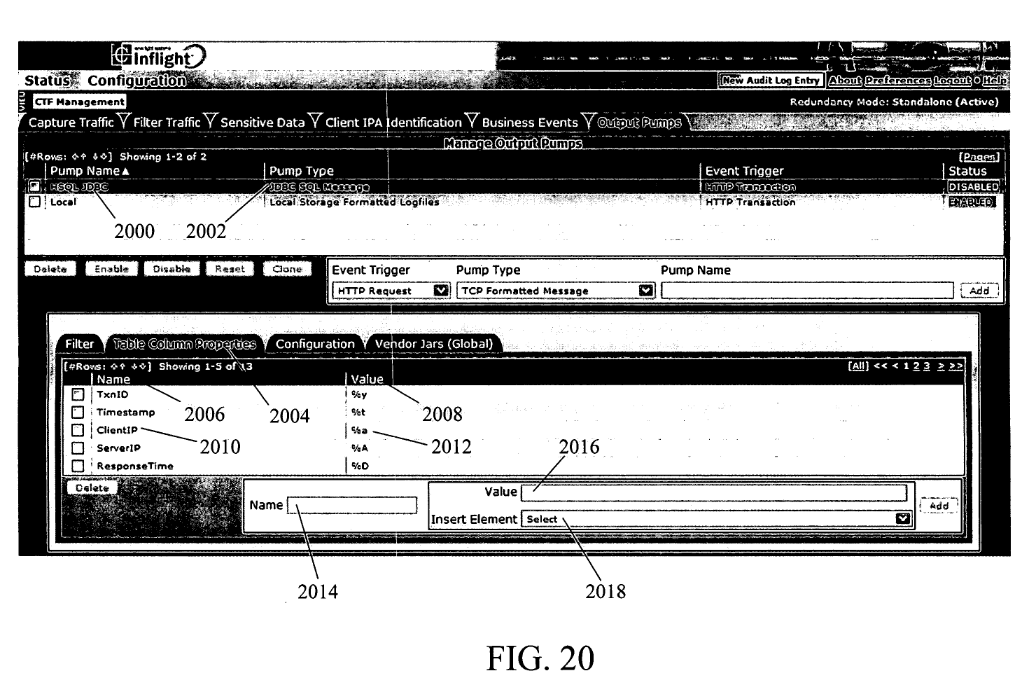

FIG. 20 shows a screen display of exemplary information for a pump that writes captured and transformed events into a data table using a JDBC interface according to an embodiment of the subject matter described herein. Referring to FIG. 20, the screen display is the same the screen display of FIG. 17, except that the screen display of FIG. 20 shows that the selected pump is “HSQL JDBC” in portion 2000. Further, the pump type shown in column 2002 shows that the pump is a “JDBC SQL Message” pump. A “Table Column Properties” tab 2004 allows the operator to map extractors into the columns of a database table. A “Name” column 2006 shows the table column name to-use. A “Value” column 2008 shows the extractor expression that is written for this column each row in the table. Each new table row in the database can correspond to an application protocol or business-level event processed by system 102. By way of example, entry 2010 shows that a column name “ClientIP” in the table should be filled using the result of the expression “% a” 2012. This expression returns the client's IP address in dotted-quad notation.

Additional mappings can be created by filling in the column name in input field 2014 and an extractor expression in input field 2016. The “Insert Element” drop down selection box 2018 provides a shortcut method of writing extractor expressions as it fills in a value for input field 2016 from a predefined list.

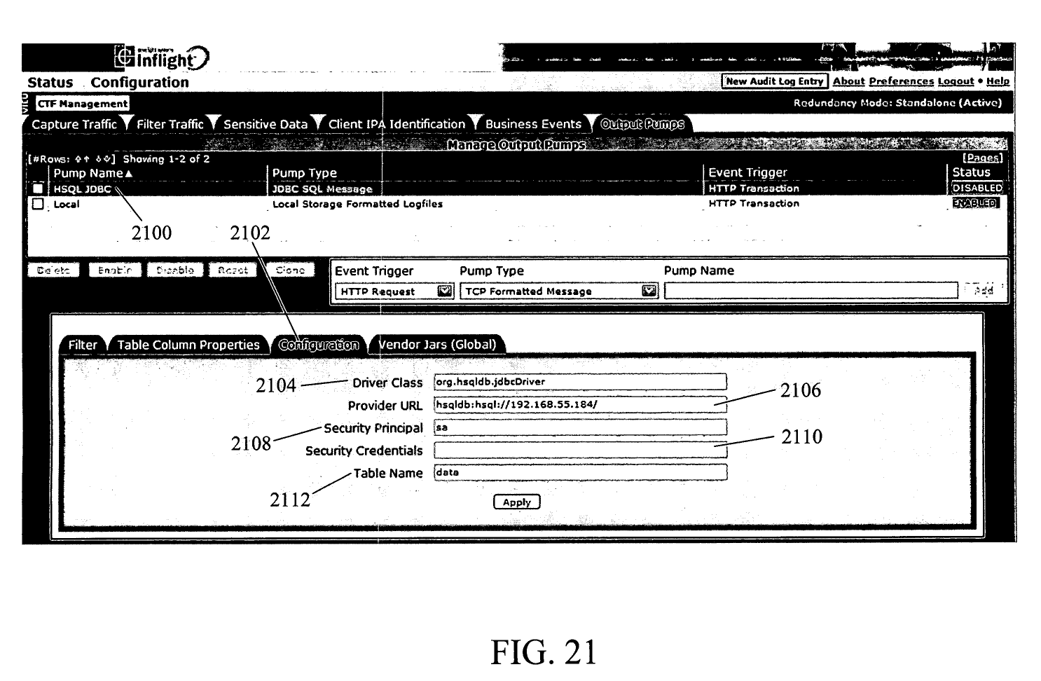

FIG. 21 is a screen display showing JDBC configuration for the same pump according to an embodiment of the subject matter described herein. Referring to FIG. 21, portion 2000 again shows that the “HSQL JDBC” pump is selected. A “Configuration” tab 2102 allows the operator to specify required JDBC configuration parameters. “Driver Class” input field 2104 can allow selection of a JDBC driver implementation. “Provider URL” input field 2106 can provide the location of the database server for communication. “Security Principal” input field 2108 can allow a user name to be entered for connecting to the database server. “Security Credentials” input field 2110 can allow a user to enter credentials for the user. “Table Name” input field 2112 can show the name of the table in the database that inserts should be performed on.

By using the subject matter described herein, an organization can relocate critical monitoring functionality into the network as a centrally managed infrastructure for meeting monitoring requirements. This approach has a low cost of deployment and maintenance, and achieves greater flexibility while meeting the requirements of real-time event processing. A distinguishing characteristic of the system described herein is that it is essentially transparent to, and never interferes with, the production environment because it uses passive network capture to acquire raw event data.

The subject matter described herein may be implemented using a computer readable medium containing a computer program, executable by a machine, such as a computer. Exemplary computer readable media suitable for implementing the subject matter described herein include chip memory devices, disk memory devices, programmable logic devices, application specific integrated circuits, and downloadable electrical signals. In addition, a computer-readable medium that implements the subject matter described herein may be located on a single device or computing platform or may be distributed across multiple devices or computing platforms.

The executable instructions of a computer program for carrying out the methods illustrated herein and particularly in FIGS. 3, 5, 6, 8A, 8B, 8C, 9A, 9B, 11, and 12 can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for passively transforming Internet protocol (IP) network traffic, the method comprising:
(a) identifying one of an application protocol event and a business-level event in IP network traffic;
(b) transforming data associated with the identified event into a usable format; and
(c) feeding the transformed data in real-time to a backend system.

2. The method of claim 1 wherein identifying one of an application protocol event and a business-level event includes identifying one of a hypertext transfer protocol (HTTP) event and a hypertext transfer protocol over secure socket layer (HTTPS) event.

3. The method of claim 1 wherein identifying one of an application protocol event and a business-level event includes identifying a sequence of client-server exchanges that collectively represent a business-level transaction.

4. The method of claim 3 comprising correlating the sequence of client-server exchanges to an application session of a user.

5. The method of claim 1 wherein identifying one of an application protocol event and a business-level event includes filtering the IP network traffic based on protocol characteristics.

6. The method of claim 1 wherein identifying one of an application protocol event and a business-level event includes identifying one of an application protocol event and a business-level event based on application client-server exchanges from a plurality of clients to and from a plurality of application servers.

7. The method of claim 1 comprising delivering the identified event onto an enterprise message bus using Java messaging service (JMS) interfaces.

8. The method of claim 1 comprising delivering the identified event to a backend system using transmission control protocol (TCP) connections.

9. The method of claim 1 comprising delivering the identified event as rows in a database using Java database connectivity (JDBC) interfaces.

10. The method of claim 1 comprising recording the identified event as a log file on a file system.

11. The method of claim 10 comprising recording the log file on a local file system.

12. The method of claim 10 comprising recording the log file on a remote file system.

13. The method of claim 12 comprising accessing the remote file system as a file share using server message block (SMB)/common Internet file system (CIFS) protocol.

14. The method of claim 12 comprising accessing the remote file system using network file system (NFS) protocol.

15. The method of claim 1 wherein the identified event includes application client-server exchanges.

16. The method of claim 15 comprising:
(a) determining that the identified event only includes client request data; and
(b) in response to determining that the identified event only includes client request data, delivering information associated with the identified event to the backend system before receiving a server response to the client request.

17. The method of claim 1 wherein feeding the transformed data includes feeding transformed data including a selected and interpreted subset of data present in the network traffic and information derived from the data in the network traffic.

18. The method of claim 1 wherein feeding the transformed data includes feeding the transformed data to the backend system using user datagram protocol (UDP) connections.

19. The method of claim 1 wherein feeding the transformed data includes feeding the transformed data to the backend system using system log (SYSLOG) protocol.

20. The method of claim 1 comprising simultaneously feeding the transformed data to multiple and different backend systems.

21. A system for passively transforming Internet protocol (IP) network traffic, the system comprising:
(a) a capture engine configured to identify one of an application protocol event and a business-level event in IP network traffic;
(b) a transformation engine configured to transform data associated with the identified event into a usable format; and
(c) a feed engine configured to feed the transformed data in real-time to a backend system.

22. The system of claim 21 wherein the capture engine is configured to identify one of a hypertext transfer protocol (HTTP) event and a hypertext transfer protocol over secure socket layer (HTTPS) event.

23. The system of claim 21 wherein the capture engine is configured to identify a sequence of client-server exchanges that collectively represent a business-level transaction.

24. The system of claim 23 wherein the capture engine is configured to correlate the sequence of client-server exchanges to an application session of a user.

25. The system of claim 21 wherein the capture engine is configured to filter the IP network traffic based on protocol characteristics.

26. The system of claim 21 wherein the capture engine is configured to identify one of an application protocol event and a business-level event based on application client-server exchanges from a plurality of clients to and from a plurality of application servers.

27. The system of claim 21 wherein the feed engine is configured to deliver the identified event onto an enterprise message bus using Java messaging service (JMS) interfaces.

28. The system of claim 21 wherein the feed engine is configured to deliver the identified event to a backend system using transmission control protocol (TCP) connections.

29. The system of claim 21 wherein the feed engine is configured to deliver the identified event as rows in a database using Java database connectivity (JDBC) interfaces.

30. The system of claim 21 wherein the capture engine is configured to record the identified event as a log file on a file system.

31. The system of claim 30 wherein the capture engine is configured to record the log file on a local file system.

32. The system of claim 30 wherein the capture engine is configured to record the log file on a remote file system.

33. The system of claim 32 wherein the capture engine is configured to access the remote file system as a file share using server message block (SMB)/common Internet file system (CIFS) protocol.

34. The system of claim 32 wherein the capture engine is configured to access the remote file system using network file system (NFS) protocol.

35. The system of claim 21 wherein the identified event includes application client-server exchanges.

36. The system of claim 35 wherein the capture engine is configured to:
(a) determine that the identified event only includes client request data; and
(b) deliver information associated with the identified event to the backend system before receiving a server response to the client request in response to determining that the identified event only includes client request data.

37. The system of claim 21 wherein the feed engine is configured to feed transformed data including a selected and interpreted subset of data present in the network traffic and information derived from the data in the network traffic.

38. The system of claim 21 wherein the feed engine is configured to feed the transformed data to the backend system using user datagram protocol (UDP) connections.

39. The system of claim 21 wherein the feed engine is configured to feed the transformed data to the backend system using system log (SYSLOG) protocol.

40. The system of claim 21 wherein the feed engine is configured to simultaneously feed the transformed data to multiple and different backend systems.

41. A computer program product comprising computer-executable instructions embodied in a computer-readable medium for performing steps comprising:
(a) identifying one of an application protocol event and a business-level event in IP network traffic;
(b) transforming data associated with the identified event into a usable format; and
(c) feeding the transformed data in real-time to a backend system.

42. The computer program product of claim 41 wherein identifying one of an application protocol event and a business-level event includes identifying one of a hypertext transfer protocol (HTTP) event and a hypertext transfer protocol over secure socket layer (HTTPS) event.

43. The computer program product of claim 41 wherein identifying one of an application protocol event and a business-level event includes identifying a sequence of client-server exchanges that collectively represent a business-level transaction.

44. The computer program product of claim 43 comprising correlating the sequence of client-server exchanges to an application session of a user.

45. The computer program product of claim 41 wherein identifying one of an application protocol event and a business-level event includes filtering the IP network traffic based on protocol characteristics.

46. The computer program product of claim 41 wherein identifying one of an application protocol event and a business-level event includes identifying one of an application protocol event and a business-level event based on application client-server exchanges from a plurality of clients to and from a plurality of application servers.

47. The computer program product of claim 41 comprising delivering the identified event onto an enterprise message bus using Java messaging service (JMS) interfaces.

48. The computer program product of claim 41 comprising delivering the identified event to a backend system using transmission control protocol (TCP) connections.

49. The computer program product of claim 41 comprising delivering the identified event as rows in a database using Java database connectivity (JDBC) interfaces.

50. The computer program product of claim 41 comprising recording the identified event as a log file on a file system.

51. The computer program product of claim 50 comprising recording the log file on a local file system.

52. The computer program product of claim 50 comprising recording the log file on a remote file system.

53. The computer program product of claim 52 comprising accessing the remote file system as a file share using server message block (SMB)/common Internet file system (CIFS) protocol.

54. The computer program product of claim 52 comprising accessing the remote file system using network file system (NFS) protocol.

55. The computer program product of claim 41 wherein the identified event includes application client-server exchanges.

56. The computer program product of claim 55 comprising:
(a) determining that the identified event only includes client request data; and
(b) in response to determining that the identified event only includes client request data, delivering information associated with the identified event to the backend system before receiving a server response to the client request.

57. The computer program product of claim 41 wherein feeding the transformed data includes feeding transformed data including a selected and interpreted subset of data present in the network traffic and information derived from the data in the network traffic.

58. The computer program product of claim 41 wherein feeding the transformed data includes feeding the transformed data to the backend system using user datagram protocol (UDP) connections.

59. The computer program product of claim 41 wherein feeding the transformed data includes feeding the transformed data to the backend system using system log (SYSLOG) protocol.

60. The computer program product of claim 41 comprising simultaneously feeding the transformed data to multiple and different backend systems.
